(19) United States
(12) Patent Application Publication
(10) Pub. No.: US 2026/0289705 A1
(43) Pub. Date: Sep. 24, 2026

(54) SYSTEM

(71) Applicant: SoftBank Group Corp., Tokyo (JP)

(72) Inventor: Shion FUKUSHIMA, Tokyo (JP)

(73) Assignee: SoftBank Group Corp., Tokyo (JP)

(21) Appl. No.: 19/560,145

(22) Filed: Mar. 9, 2026

(30) Foreign Application Priority Data
Mar. 19, 2025 (JP) 2025-044940

(51) Int. Cl. G06Q 50/18; G06F 16/242; G06F 16/2457; G06F 40/284; G06N 3/0475

(52) U.S. Cl. CPC G06Q 50/184; G06F 16/243; G06F 16/24575; G06F 16/24578; G06N 3/0475; G06F 40/284; G06F 2216/11

(57) ABSTRACT

A system includes a processor, in which the processor is configured to: receive information from a user and generate a prompt sentence; input the prompt sentence into a generative AI model and analyze information by using the generative AI model; and integrate a plurality of intellectual property databases and search information in the databases based on an analysis result obtained from the generative AI model.

### CROSS-REFERENCE TO RELATED APPLICATION

This application is based on and claims priority under 35 USC 119 from Japanese Patent Application No. 2025-044940 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional intellectual property (IP) search and risk assessment systems require users to manually formulate search queries and individually access multiple IP databases. Such systems place a heavy burden on users, because users must translate their own technical or business descriptions into specialized search expressions and must interpret search results without integrated analytical support. In addition, existing systems generally do not leverage generative AI models to flexibly interpret user input, nor do they dynamically adjust infringement risk evaluations based on the emotional state or situational context of the user. Furthermore, conventional systems do not adequately route analyzed information to appropriate internal departments or services in an automated and timely manner, thereby causing delays and inefficiencies in corporate decision-making and IP risk management. Accordingly, there is a need for a system that can receive information directly from a user, utilize a generative AI model to analyze the information, integrate and search multiple intellectual property databases on the basis of the analysis result, adjust infringement risk evaluations in accordance with the user's emotional state, and automatically classify and notify relevant departments and services.

### SUMMARY

In order to solve the above-described problems, a system according to one embodiment of the present invention comprises a processor, wherein the processor is configured to receive information from a user and generate a prompt sentence, input the prompt sentence into a generative AI model and analyze information by using the generative AI model, and integrate a plurality of intellectual property databases and search information in the databases based on an analysis result obtained from the generative AI model. The processor is further configured to analyze an emotional state of the user and adjust an evaluation of intellectual property infringement risk based on the emotional state, thereby enabling a more context-sensitive and user-adaptive risk assessment. In addition, the processor is configured to classify information into appropriate departments or services based on the analysis result and notify the user, which allows relevant organizational units to receive timely and targeted information and supports efficient internal workflows related to intellectual property strategy and risk management.

The term “processor” refers to one or more hardware processing units, such as a central processing unit (CPU), a graphics processing unit (GPU), a digital signal processor (DSP), an application-specific integrated circuit (ASIC), a field-programmable gate array (FPGA), or any combination thereof, configured to execute instructions for implementing functions described in the present specification.

The term “prompt sentence” refers to a text string, a sequence of tokens, or other machine-readable representation that is generated from information received from a user and that is provided as input to a generative AI model in order to cause the generative AI model to perform an analysis or generation operation.

The term “generative AI model” refers to a machine learning model, such as a large language model or other generative model, that is trained on data to generate or transform text or other content and that is configured to perform analysis of input information based on learned statistical relationships.

The term “intellectual property database” refers to a data storage system that stores information related to intellectual property, such as patent documents, patent applications, patent classifications, prior art references, trademark records, copyright registrations, licensing information, or judicial decisions related to intellectual property.

The term “plurality of intellectual property databases” refers to two or more intellectual property databases that may be heterogeneous in structure, format, jurisdiction, or content and that can be accessed and processed in an integrated manner by the system.

The term “integrate” refers to the operation of combining, normalizing, correlating, or otherwise processing data from multiple sources so that information stored in different intellectual property databases can be searched, analyzed, or presented in a unified or coordinated manner.

The term “search information in the databases” refers to performing retrieval operations on one or more intellectual property databases, including keyword search, structured query search, semantic search, or other retrieval techniques, in order to obtain records relevant to an analysis result or user request.

The term “analysis result” refers to output data produced by the generative AI model or associated processing, including extracted features, classifications, summaries, similarity scores, or other derived information obtained from analysis of a user's input or prompt sentence.

The term “emotional state of the user” refers to an inferred or detected psychological condition or affect of the user, such as stress, urgency, confidence, uncertainty, or other emotional or attitudinal indicators, which may be derived from user inputs, interaction patterns, or additional sensor data.

The term “evaluation of intellectual property infringement risk” refers to an assessment, scoring, classification, or other representation of the likelihood or severity that a particular activity, product, or service may infringe one or more intellectual property rights, such as patent rights, based on technical and legal analysis.

The term “adjust an evaluation of intellectual property infringement risk” refers to modifying, weighting, or recalculating a previously determined risk assessment in response to additional factors, including the emotional state of the user or other context-related information.

The term “classify information into appropriate departments or services” refers to assigning analyzed information to one or more target organizational units, roles, or functional services, such as legal departments, R&D departments, business units, IP management services, or external advisory services, based on the content or characteristics of the analysis result.

The term “notify the user” refers to providing information to a user by means of a user interface, which may include displaying a message on a screen, sending an email, transmitting a notification to a client application, or using another communication channel to inform the user of analysis results, classifications, or actions taken by the system.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

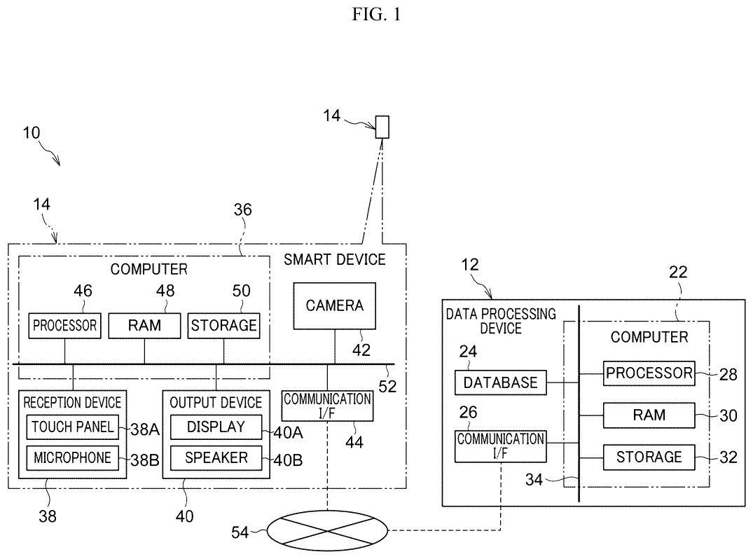

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

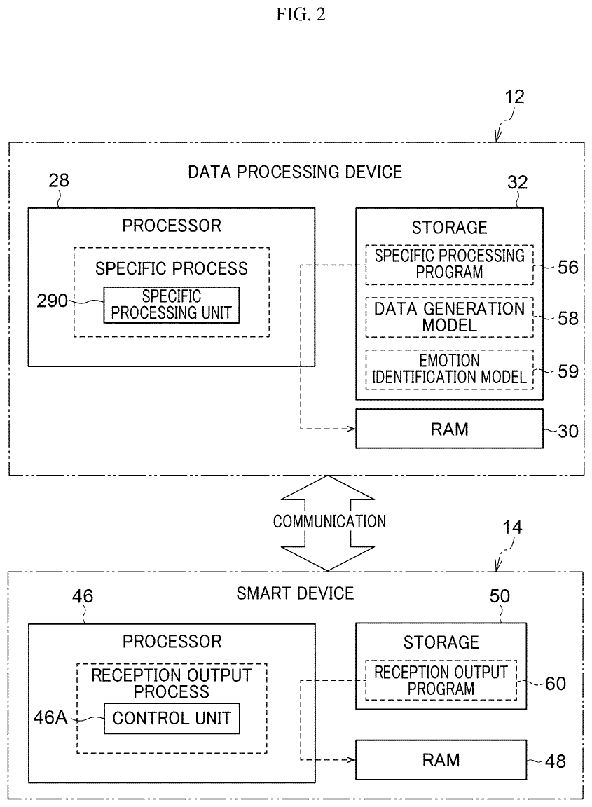

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional approaches to assessing intellectual property infringement risk for new business technologies rely heavily on manual review of heterogeneous data sources, such as multiple patent databases and separate legal case repositories. In such approaches, a human expert must independently formulate search queries, access different information systems, reconcile inconsistent data formats, and mentally correlate technical descriptions of a proposed technology with patent claim language and judicial interpretations in case law. This fragmented workflow leads to significant latency, increased probability of human error, and inconsistent risk evaluations.

In addition, existing computer-implemented systems that support intellectual property searches are generally limited to keyword-based retrieval and do not provide an integrated, machine-interpretable representation that links technical features, rights information, and case information. These systems typically do not exploit advanced natural language processing to derive structured risk indicators or to automatically tailor the presentation of results for downstream computational use, such as routing to internal departments or external service providers. Consequently, the processing performed by such systems is inefficient from a computer-technology standpoint, because network resources, storage resources, and processor time are consumed by redundant or low-value operations, while the core task of correlating heterogeneous legal and technical texts remains largely manual.

Furthermore, known systems do not provide a systematic mechanism to generate and manage prompt sentences for a generative AI model in a way that is optimized for machine processing of large volumes of technical, patent, and legal text. Without an automated pipeline that normalizes user input, constructs structured queries, aggregates retrieved data, generates standardized prompts, and converts free-form AI outputs into structured evaluation data, the computer system cannot efficiently scale to handle multiple concurrent analyses or support consistent, repeatable risk assessments. This lack of integration and structure degrades the overall performance and utility of the computer system, particularly in environments requiring rapid assessment of infringement risk for many candidate technologies.

Accordingly, there is a need for an improved computer-implemented system that programmatically receives technical content relating to a business activity, automatically generates and refines search queries, integrates results from multiple intellectual property and legal information storage apparatuses, constructs optimized prompt sentences for a generative AI model, and transforms the resulting analysis into structured evaluation data. Such a system should improve the functioning of the computer itself by reducing redundant data retrieval, standardizing heterogeneous data into unified internal representations, and enabling automated classification and routing of results to appropriate entities.

The specific processing by the specific processing unit 290 of the data processing device 12 in Example 1 is realized by the following means.

The present invention provides a server comprising a processor configured to receive, from an information processing terminal of a user, data indicating technical content relating to a business activity, acquire text data representing the technical content, and perform normalization of terms, extraction of characteristic terms, and generation of a search query on the text data; communicate, via one or more communication interfaces, with a plurality of intellectual property information storage apparatuses and legal information storage apparatuses on the basis of the text data and the search query, acquire recorded data including right information from the intellectual property information storage apparatuses and recorded data including case information from the legal information storage apparatuses, and associate and store the acquired right information and case information in a unified data structure; generate a prompt sentence including the technical content, the right information, and the case information as an input text for a generative AI model, input the prompt sentence into the generative AI model, and acquire an analysis result concerning a correspondence relationship between the technical content and the right information and a possibility of infringement; and generate evaluation result data including the right information and the case information related to the technical content on the basis of the analysis result, including extraction of an evaluation index indicating a degree of infringement risk, addition of risk classification information, structuring of the evaluation result data, and transmission of the evaluation result data to the information processing terminal and to one or more designated entities in accordance with classification of the right information and the case information. This enables improved computer-implemented processing for intellectual property risk assessment by automatically integrating heterogeneous technical and legal data sources, optimizing prompt sentences for a generative AI model, and converting unstructured analysis results into structured data suitable for efficient storage, retrieval, automated routing, and consistent, scalable infringement-risk evaluation.

The term “system” refers to a combination of one or more computing devices and communication resources that cooperate to perform the functions described in the claims, including receiving input data, processing the data, and providing output data.

The term “processor” refers to one or more hardware processing units, such as a central processing unit or a processing core, configured to execute instructions stored in a memory to perform the functions recited in the claims.

The term “information processing terminal” refers to an electronic device operated by a user, such as a general-purpose computer, a mobile communication device, or any other data input/output device, that is capable of transmitting data to and receiving data from the system over a communication network.

The term “user” refers to a human operator or an entity that causes the information processing terminal to provide technical content or other data to the system for analysis.

The term “business activity” refers to any planned or existing commercial, industrial, or service-related operation or project for which technical content is to be evaluated.

The term “technical content” refers to information describing a configuration, method, or function of a technology, such as features of hardware, software, or processes associated with a business activity.

The term “text data” refers to data representing characters, words, sentences, or other linguistic units, encoded in a machine-readable format, that express the technical content.

The term “normalization of terms” refers to processing operations that convert variations in spelling, capitalization, inflection, or formatting of words or phrases into a standardized representation suitable for computational analysis.

The term “extraction of characteristic terms” refers to identifying and selecting words, phrases, or other linguistic units within text data that are determined to be relevant for distinguishing or describing the technical content.

The term “search query” refers to a structured data string, including one or more terms and optional operators, generated for submission to an information storage apparatus to request retrieval of stored data relevant to the technical content.

The term “communication interface” refers to one or more hardware and software components that enable the processor to transmit data to and receive data from external apparatuses via a communication network.

The term “intellectual property information storage apparatus” refers to a data storage system, such as a database server or repository, that stores and provides access to information regarding intellectual property rights, including but not limited to patent information.

The term “legal information storage apparatus” refers to a data storage system, such as a database server or repository, that stores and provides access to information regarding legal documents, including but not limited to case law, judicial decisions, and legal analyses.

The term “recorded data” refers to information stored in a storage medium of an information storage apparatus, in a format retrievable by the processor.

The term “right information” refers to data describing intellectual property rights, including identification numbers, titles, abstracts, claims, filing data, ownership, and classification information associated with the rights.

The term “case information” refers to data describing legal proceedings or decisions, including case names, court information, decision dates, cited rights, and summaries of holdings or reasoning.

The term “associate and store” refers to performing operations that link related data items, such as right information and case information, by one or more identifiers or relationships, and recording the linked data in a memory or storage device.

The term “prompt sentence” refers to a text sequence, including one or more instructions, descriptions, and contextual information, generated for input to a generative AI model to cause the model to perform an analysis.

The term “generative AI model” refers to a machine learning model configured to generate text or other content in response to input data, based on patterns learned from training data, and capable of performing natural language understanding and generation.

The term “input text for a generative AI model” refers to text data, including the prompt sentence and associated information, that is supplied to the generative AI model to cause the model to produce an output.

The term “analysis result” refers to output data generated by the generative AI model that indicates relationships, evaluations, or interpretations concerning the technical content, right information, and case information.

The term “correspondence relationship” refers to an identified association or similarity between elements of the technical content and elements of the right information, such as overlap between technical features and claim elements.

The term “possibility of infringement” refers to an estimated likelihood that implementation of the technical content would fall within the scope of one or more intellectual property rights.

The term “evaluation result data” refers to structured or semi-structured data derived from the analysis result and related information, including summaries, risk assessments, and listings of associated rights and cases.

The term “evaluation index” refers to one or more numerical or categorical values derived from the analysis result, indicating a degree or level of infringement risk or other assessment metrics.

The term “risk classification information” refers to data that categorizes the infringement risk into predefined classes, such as low, medium, or high, based on the evaluation index.

The term “structured data” refers to data organized according to a defined schema, such as key-value pairs, tables, or hierarchical objects, enabling efficient storage, retrieval, and processing by a computer.

The term “classification” refers to assigning data items, such as right information or case information, to one or more categories or groups according to predetermined rules or criteria derived from the analysis result.

The term “internal responsible department” refers to a functional unit within an organization, such as a legal department, research and development department, or management department, that is designated to receive and act on the evaluation result data.

The term “external support entity” refers to an organization or individual outside the user's organization, such as a service provider or consultant, that is designated to receive the evaluation result data and provide assistance based on the data.

The term “notification information” refers to data indicating that evaluation result data is available, and optionally including at least part of the evaluation result data, destination identifiers, and control information for distributing the evaluation result data to one or more entities.

The term “display control” refers to operations performed by the system to cause an information processing terminal to present evaluation result data on a display device in a specified format.

The server, the terminal, and the user cooperate to implement embodiments of the invention as described below. Each embodiment supports the claimed invention and can be implemented using general-purpose computing hardware and software appropriately configured as described.

In one embodiment, the server is implemented by a computing apparatus that includes at least one processor, a main memory, a non-volatile storage device, a network interface, and a display interface. The processor is, for example, a multi-core central processing unit. The main memory is, for example, a semiconductor memory such as a dynamic random access memory. The non-volatile storage device is, for example, a magnetic disk device, a solid-state drive, or another persistent storage device. The network interface is, for example, an Ethernet or wireless communication adapter configured to communicate over an Internet Protocol network. The server executes an operating system, such as a general-purpose server operating system, and one or more application programs implementing a web application framework such as a web server and an application server. The application programs include modules written in a high-level programming language executed by interpreters or runtimes, for example a Python interpreter executing a web framework, or a JavaScript runtime executing a server-side framework.

The terminal is implemented by an information processing device such as a personal computer, a tablet terminal, or a smartphone. The terminal includes at least one processor, a memory, a display device such as a liquid crystal display or organic light emitting diode display, an input device such as a keyboard, a pointing device, or a touch panel, and a communication interface for connecting to the network. The terminal executes a web browser application capable of establishing secure connections to the server using a secure communication protocol, for example HTTPS. The terminal renders user interfaces transmitted from the server and transmits user input back to the server.

The user operates the terminal to access a web page provided by the server. The user inputs technical content relating to a business activity, such as a planned product or service, into an input field presented on the display of the terminal. The technical content is expressed in natural language and may include functional descriptions, system architectures, data processing methods, and intended use cases. The terminal converts the user input into text data and transmits the text data to the server via the network.

The server receives the text data as a request message through the network interface and web framework. The server stores the received text data in main memory and may also store it in a structured record in the non-volatile storage device. The server executes a text preprocessing module that performs normalization of terms. In this module, the server converts the text data to a unified character encoding, converts uppercase characters to lowercase, removes diacritical marks where appropriate, and tokenizes the text into units such as words and symbols using a deterministic tokenization algorithm. The server replaces certain inflected forms with their base forms using a lemmatization table stored in the non-volatile storage device, and removes stop words to reduce noise. The server then extracts characteristic terms by computing term frequency and inverse document frequency values based on a corpus stored in the storage device, and identifies high-weight terms as characteristic terms representing important features of the technical content.

The server constructs a search query based on the characteristic terms and on predetermined query templates. The server builds the search query as a data structure that includes token strings, Boolean operators, and optional field constraints adapted to an external intellectual property information storage apparatus and to an external legal information storage apparatus. By using this data structure, the server avoids recomputing query formatting and thus reduces processing time when constructing different queries for multiple databases. The server then encodes the data structure into request parameters for use in a network protocol and transmits the encoded query to an intellectual property information storage apparatus via the network interface.

The server communicates with a plurality of intellectual property information storage apparatuses, for example patent databases operated by different organizations. The server receives recorded data from each apparatus in a machine-readable format such as a structured markup or a serialized object representation. The server executes a parsing module that converts the recorded data into a unified internal schema. In this schema, the server stores for each right information item at least an identification number, a title, an abstract, a set of claims, classification codes, and bibliographic information. The server stores the unified records in the non-volatile storage device as structured data, for example in a relational database or a document-oriented database. This unified representation improves data management by allowing indexed queries and by enabling efficient joins between different data sources without repeated transformation.

The server also communicates with one or more legal information storage apparatuses, for example case law databases. The server transmits search queries including right identification numbers and characteristic terms to the legal information storage apparatuses and receives case information data. The server parses the case information into a unified schema that includes at least a case identifier, a case title, a court identifier, a decision date, cited rights, and a summary of judgments. The server stores the parsed case information in the non-volatile storage device with indexes that reference the associated right information. In this way, the server associates and stores right information and case information and maintains their relationships through identifiers, thereby reducing the need for repeated full-text searching in later processing and reducing communication load on external databases.

The server constructs a prompt sentence as input text for a generative AI model. In one embodiment, the server implements separate modules for selecting relevant right information and case information. The server ranks right information based on similarity between the technical content and claim texts by computing vector representations of textual data using a feature extraction method such as word embeddings or subword embeddings. For example, the server may apply a precomputed embedding model to map tokens to vectors in a high-dimensional space and then compute cosine similarity between aggregated vectors of the technical content and the claims. The server selects those right information records whose similarity scores exceed a threshold or are among the top predetermined number. Similarly, the server uses vector representations of case summaries to select case information that is both related to the selected rights and similar to the technical content.

The server generates the prompt sentence by concatenating sections including: (i) a description of the technical content; (ii) summaries and selected claim elements from the selected right information; and (iii) summaries of the selected case information. The server also includes explicit instructions to the generative AI model regarding the analysis task and the required output format. For example, the server generates a prompt sentence such as:

“Analyze the potential patent infringement risks for the following new business technology:
‘AI-based image recognition technology for classifying products in an e-commerce platform.’
   Compare This Technology with the Following Patents and Their Key Claims:
Patent A: [insert main claim text or summary]
Patent B: [insert main claim text or summary]

### Also Consider the Following Related Cases:

Case C: [insert brief summary of the ruling]
Case D: [insert brief summary of the ruling]

Based on this information, identify which claims might be infringed, describe the likelihood and severity of infringement risk, and explain how the cited case law affects the overall risk assessment.”

The server provides the prompt sentence as input text to a generative AI model. In one embodiment, the generative AI model is implemented by a neural network model having a transformer architecture. The model comprises an input embedding layer that converts tokens into numerical vectors, multiple self-attention layers that compute attention scores between tokens to capture contextual relationships, feed-forward layers with non-linear activation functions, and an output layer that generates tokens representing analysis text. The server invokes the generative AI model through an application programming interface, passing the prompt sentence and configuration parameters such as maximum output length, sampling temperature, and probability thresholds. The generative AI model has been trained in advance on a large corpus of technical, legal, and general-purpose texts by minimizing a loss function such as cross-entropy between predicted tokens and ground-truth tokens, and by updating model parameters through stochastic gradient descent with backpropagation.

The server, by controlling the structure and content of the prompt sentence, causes the generative AI model to perform a specialized form of analysis that differs from simple human search behavior. The generative AI model processes the tokenized prompt sentence and computes internal activations representing interactions between the technical content, right information, and case information. The server receives the analysis result as a generated text that includes, for example, identification of overlapping functional elements, references to particular claim limitations, explanations of potential infringement, and qualitative assessments of risk levels. Because the prompt sentence encodes structured instructions and context, the internal attention patterns of the model are biased toward aligning specific technical features with specific claim elements and legal reasoning segments, thereby improving the accuracy and consistency of the generated analysis compared with ad hoc manual assessment.

The server converts the analysis result into evaluation result data. The server first parses the generated text using a parser configured with rule sets and pattern-matching expressions to identify portions that indicate risk levels, references to rights, and references to cases. The server extracts an evaluation index by converting expressions such as “high likelihood,” “moderate risk,” and “unlikely” into numerical or categorical values based on a predefined mapping table stored in the non-volatile storage device. The server assigns risk classification information, for example “HIGH,” “MEDIUM,” or “LOW,” to each right information record and to the technical content as a whole. The server then stores the evaluation result data as structured data comprising entries that reference right information identifiers, case information identifiers, and associated risk classifications.

The server performs classification of right information and case information based on the evaluation result data. The server assigns each right information item to one or more classes, such as “critical risk,” “potential risk,” or “background reference,” and assigns each case information item to categories such as “supporting infringement,” “supporting non-infringement,” or “interpretation of scope.” To determine these classes, the server applies a rule-based classifier that combines the evaluation index, relationship strength between technical features and claim features, and prior classification rules stored in the non-volatile storage device. Because this classification is implemented as an algorithmic combination of multiple factors in a reproducible manner, the server can process large numbers of records more quickly and consistently than manual classification.

The server generates notification information indicating destinations for the evaluation result data. In one embodiment, the server stores mapping information between risk classification categories and destination entities, such as internal departments or external support entities. For example, a “HIGH” risk category may be mapped to a legal department and an external legal advisor, whereas a “LOW” risk category may be mapped only to an internal research and development department. The server composes notification information including identifiers of the destination entities, references to evaluation result data records, and control flags indicating required actions. By generating and storing this notification information, the server enables subsequent routing and access control processing that use the structured evaluation results more efficiently.

The terminal receives evaluation result data from the server. The terminal displays, on the display device, a structured view of the evaluation result data. This view may include sortable tables of right information with associated risk classifications, expandable sections showing analysis reasoning, and hyperlinks to case information summaries. The terminal may also provide graphical indicators such as color coding or icons to emphasize high-risk items. The user inspects the displayed information and may adjust planning or seek further expert advice using the structured data. Because the server has already performed normalization, unification, and risk classification, the terminal can perform lightweight rendering without heavy computation, thereby reducing resource usage at the terminal side.

The server improves computer technology in several ways. First, by unifying heterogeneous data from multiple storage apparatuses into a single internal schema and by reusing pre-computed vector representations and indexes, the server reduces the number of network requests and the need for repeated parsing and normalization, which reduces communication load and processing time. Second, by generating structured prompt sentences that selectively include only the most relevant right and case information, the server reduces the input length to the generative AI model and thereby decreases compute cost and latency in the model inference. Third, by converting unstructured model outputs into structured evaluation result data through algorithmic parsing and classification, the server enables fast retrieval and reuse of prior analyses, improving storage efficiency and enabling incremental updates without repeating the entire analysis pipeline.

The server uses a training method for the generative AI model that includes data augmentation specific to technical and legal texts. For example, during offline training, the server or a model provider may generate synthetic variations of technical descriptions and legal reasoning by paraphrasing, reordering clauses, or replacing synonyms, while preserving meaning. These augmented data improve robustness of the model to different writing styles. The training procedure includes defining an error function such as token-level cross-entropy, computing gradients by backpropagation through the transformer layers, and updating weight parameters with an optimizer algorithm such as Adam. By using large-scale training, the model learns nuanced patterns between technical features and legal concepts that human analysts may overlook or that would be cost-prohibitive to encode in static rule sets. This learning process allows the server to leverage the generative AI model as a specialized computational engine whose internal parameters encode complex correlations not easily captured by traditional search algorithms.

The server also uses a non-conventional combination of rule-based processing and neural network inference. Rather than simply replacing human experts, the server constrains the generative AI model with structured prompts and post-processing rules. For example, the server may reject or re-evaluate model outputs that do not mention all required claim elements or that conflict with predefined legal taxonomies, thereby enforcing consistency. The server may also perform a second inference pass with a different prompt sentence that asks the generative AI model to verify or critique the first pass output. This multi-pass, rule-constrained architecture uses the generative AI model as a component in a larger system optimized for technical performance, rather than as a black-box replacement of human reasoning.

In an alternative embodiment, the server deploys multiple generative AI models with different sizes or specialization domains. The server may select a smaller model for low-risk or preliminary analyses and a larger, more computationally intensive model for complex or high-stakes analyses, based on an initial evaluation index. This dynamic selection reduces unnecessary consumption of computational resources and improves overall throughput. In another variation, the server may cache intermediate embedding vectors or partial analyses for frequently occurring technical patterns and reuse them across different user requests, further reducing processing time.

In another embodiment, the server is integrated into a larger enterprise system that includes a version control system and a project management system. The server stores evaluation result data with links to specific project artifacts in the version control system. When a project artifact is modified, the server detects changes through hooks or polling and selectively re-analyzes only the affected technical content, using previously stored normalized text and right information as a baseline. This incremental analysis approach further decreases redundant data acquisition and model invocation.

The user, by interacting with the terminal, can adapt the technical content based on the evaluation result data and submit updated content to the server. The server can thus iteratively refine the risk assessment and track the evolution of the technical content and associated risk indicators in a structured manner. Because the server maintains structured histories of evaluation result data and the relationships between technical content, right information, and case information, the system provides a technically improved platform for managing intellectual property risk evaluations in a scalable and computationally efficient way.

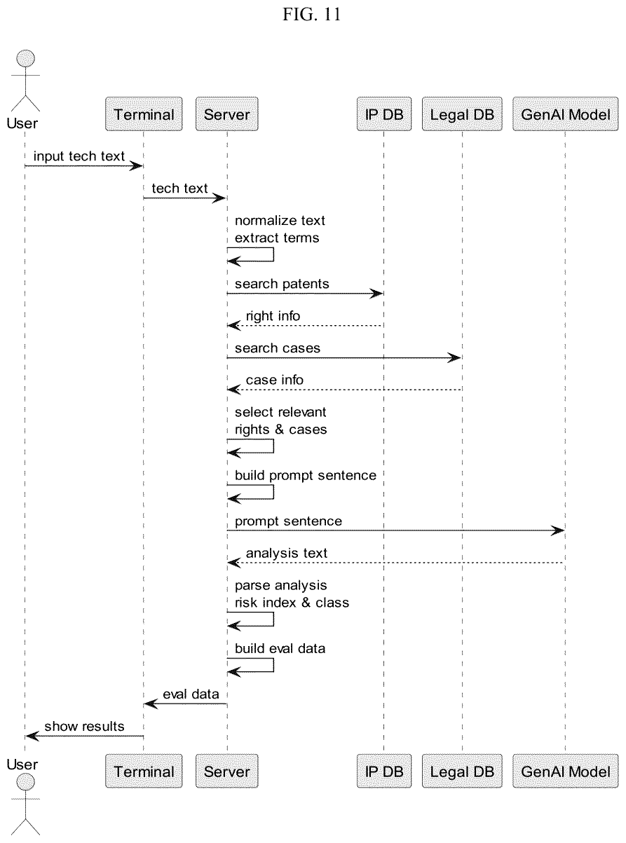

The following describes the processing flow using FIG. 11.

### Step 1:

The user operates the terminal and opens a web page provided by the server.
The terminal displays an input field for technical content relating to a business activity.
Input: The user enters natural-language text describing technical content (for example, “AI-based image recognition technology for classifying products in an e-commerce platform.”).
The terminal captures the text, wraps it into a request message, and transmits the request to the server via a secure communication protocol.
Output: The terminal outputs a network request containing the technical content text and sends it to the server.

### Step 2:

The server receives the network request from the terminal and extracts the technical content text.
Input: The server obtains the raw text data representing the technical content.
The server performs text normalization, including converting characters to a unified encoding, converting uppercase to lowercase, removing extra spaces, and tokenizing the text into words and symbols.
The server performs lemmatization and stop-word removal, and then computes frequency statistics to identify characteristic terms that represent important technical features.
Output: The server outputs normalized text data and a set of characteristic terms to be used for query generation.

### Step 3:

The server generates search queries for external information storage apparatuses based on the normalized text and characteristic terms.
Input: The server takes the normalized text and the characteristic terms as input.
The server constructs one or more structured search queries that combine the characteristic terms with Boolean operators and field constraints suitable for intellectual property databases and legal databases.
The server encodes these search queries into request parameters that can be transmitted by a network protocol.
Output: The server outputs database-specific search query data structures and encoded network requests.

### Step 4:

The server communicates with intellectual property information storage apparatuses to obtain right information.
Input: The server sends the encoded search queries to multiple intellectual property information storage apparatuses.
The server receives recorded data including right information such as identification numbers, titles, abstracts, and claims.
The server parses the recorded data, converts it into a unified internal schema, and stores the structured right information in a storage device with indexes for efficient retrieval.
Output: The server outputs a structured collection of right information records associated with the technical content.

### Step 5:

The server communicates with legal information storage apparatuses to obtain case information linked to the right information.
Input: The server uses identifiers and characteristic terms derived from the right information as input to generate legal search queries.
The server sends the legal search queries to one or more legal information storage apparatuses and receives recorded data including case information such as case identifiers, court data, decision dates, and summaries.
The server parses the legal data, maps it into a unified internal schema, and associates each case information record with corresponding right information records using shared identifiers or references.
Output: The server outputs a structured collection of case information records linked to the right information.

### Step 6:

The server selects relevant right information and case information to be included in a prompt sentence.
Input: The server takes the structured right information records, the structured case information records, and the normalized technical content as input.
The server computes similarity scores by transforming texts into numerical vectors using a feature extraction method and calculating similarity measures between the technical content and each right or case record.
The server selects a subset of right information and case information whose similarity scores satisfy predetermined selection criteria.
Output: The server outputs selected right information and case information segments suitable for inclusion in the prompt sentence.

### Step 7:

The server generates a prompt sentence for a generative AI model using the selected information.
Input: The server takes the technical content text, the selected right information summaries and claim excerpts, and the selected case information summaries as input.
The server assembles these elements into a single text sequence that includes instructions, context, and specific questions for analysis.

For example, the server generates a prompt sentence such as:

“Analyze the potential patent infringement risks for the following new business technology:
‘AI-based image recognition technology for classifying products in an e-commerce platform.’
   Compare This Technology with the Following Patents and Their Key Claims:
Patent A: [insert main claim text or summary]
Patent B: [insert main claim text or summary]

### Also Consider the Following Related Cases:

Case C: [insert brief summary of the ruling]
Case D: [insert brief summary of the ruling]

Based on this information, identify which claims might be infringed, describe the likelihood and severity of infringement risk, and explain how the cited case law affects the overall risk assessment.”
Output: The server outputs a complete prompt sentence text prepared for submission to the generative AI model.

### Step 8:

The server sends the prompt sentence to the generative AI model and obtains an analysis result.
Input: The server provides the prompt sentence and configuration parameters (such as maximum length and sampling settings) to the generative AI model.
The generative AI model processes the input text using an internal neural network and returns a generated analysis text that includes correspondence relationships between technical content and rights, potential infringement scenarios, and qualitative risk assessments.
The server receives the generated text response via a network interface.
Output: The server outputs an analysis result text produced by the generative AI model.

### Step 9:

The server converts the analysis result into structured evaluation result data.
Input: The server takes the analysis result text together with the identifiers of right information and case information as input.
The server parses the analysis text using pattern-matching rules and extraction algorithms to detect references to specific rights, to identify risk-related expressions, and to locate mentions of case information.
The server computes an evaluation index for each right information record and for the technical content overall by mapping qualitative expressions in the analysis text to numerical or categorical values.
The server assigns risk classification information such as “HIGH,” “MEDIUM,” or “LOW” based on the evaluation index and stores these classifications in association with the corresponding rights and cases.
Output: The server outputs structured evaluation result data that includes links to right information and case information, evaluation indices, and risk classifications.

### Step 10:

The server classifies right information and case information and prepares notification information.
Input: The server uses the structured evaluation result data as input.
The server applies classification rules that group right information into categories such as “critical risk,” “potential risk,” or “background,” and group case information into categories such as “supporting infringement” or “supporting non-infringement.”
The server consults stored mapping data that associates classification categories with destination entities, such as internal departments or external support entities, and generates notification information indicating which entities should receive which portions of the evaluation result data.
Output: The server outputs classification results and notification information referencing the evaluation result data.

### Step 11:

The server transmits evaluation result data to the terminal for display and to designated entities for further handling.
Input: The server uses the structured evaluation result data and the notification information as input.
The server formats the evaluation result data into a representation suitable for the terminal, including organized lists of rights, cases, and risk levels, and sends this formatted data to the terminal via the network.
The server also prepares transmission messages to other designated entities, as indicated by the notification information, and sends appropriate portions of the evaluation result data to those entities.
Output: The server outputs one or more response messages containing evaluation result data, which are transmitted to the terminal and other recipients.

### Step 12:

The terminal receives the evaluation result data and presents it to the user.
Input: The terminal obtains formatted evaluation result data from the server through the communication interface.
The terminal parses the received data and renders user interface elements on the display device, including tables listing intellectual property rights with associated risk classifications, links to case summaries, and textual explanations of the risk assessment.
The user views the displayed information on the terminal and may use it to understand potential infringement risks and to decide on further actions.
Output: The terminal outputs visual representations of the evaluation result data on the display for the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional intellectual property risk assessment for new technical functions relies heavily on manual searching of multiple heterogeneous databases and ad hoc expert analysis. In typical computerized workflows, a user manually inputs technical descriptions into separate patent and legal search interfaces, and a general-purpose computer executes straightforward keyword searches over each database independently. These existing systems do not automatically normalize and expand technical elements, do not systematically correlate patent records with relevant statutes and case law, and do not generate machine-usable risk evaluations tied back to specific technical features. As a result, the processor performs repetitive input/output operations and simple text retrieval that produce large, unstructured result sets, thereby forcing the user or an expert to perform additional cognitive work outside the computer to interpret the data. This leads to increased latency, higher computational waste due to redundant searches, and limited scalability when the volume and complexity of technical and legal data grows.

Furthermore, conventional use of machine learning or generative models in legal or intellectual property settings is typically limited to isolated text generation or document summarization. A general-purpose computer merely forwards user text to a model and displays the generated output as free-form text, without integrating the model into the core data access, correlation, and routing logic of the system. Such an arrangement leaves the underlying computer architecture underutilized, because the processor does not exploit structured intermediate representations, does not orchestrate targeted calls to specialized data stores, and does not convert model output into structured control signals that can drive further automated processing. Consequently, the system exhibits inefficiencies in memory access patterns, network usage, and processor cycles, and fails to provide predictable, machine-actionable risk indicators that can be consumed by downstream computerized workflows. There is therefore a need for a computer-implemented system in which a processor is specifically configured to (i) convert user-provided technical elements into structured search information with expanded terminology, (ii) orchestrate coordinated access to multiple heterogeneous information storage devices, including patent data stores and statute/case-law data stores, (iii) construct a prompt sentence embedding normalized, summarized, and cross-linked technical and legal information as analysis target information, (iv) invoke a generative AI model as a controlled analytical engine rather than a mere text generator, and (v) transform the model's output into structured evaluation result information that can be programmatically routed to appropriate organizational entities and used to drive subsequent automated design and risk-mitigation processes. By tightly coupling these operations at the processor level, the invention aims to improve the functioning of the computer itself in terms of data structuring, memory usage, network traffic, and automated decision support, rather than merely digitizing an existing human workflow.

The specific processing by the specific processing unit 290 of the data processing device 12 in Application Example 1 is realized by the following means.

The present invention provides a server comprising a processor configured to receive, from a user terminal, input information including technical elements related to a new function; to extract the technical elements, add synonyms and related terms, and generate structured search information; to transmit, based on the structured search information, search requests to a first information storage device storing patent information and to a second information storage device storing statute information or case law information; to acquire the patent information from the first information storage device and, based on the acquired patent information, to acquire the statute information or the case law information from the second information storage device; to summarize and integrate the input information, the patent information, and the statute information or the case law information into analysis target information; to generate a prompt sentence including the analysis target information and analysis content for evaluating intellectual property right infringement risk; to input the prompt sentence to a generative AI model and to acquire output information including an evaluation result of the intellectual property right infringement risk; to analyze the output information, to map the evaluation result to a quantitative or qualitative evaluation index, and to generate evaluation result information associated with the related patent information and the statute information or the case law information; and to transmit the evaluation result information to the user terminal and, optionally, to other terminals associated with organizational divisions or roles determined based on classification information generated from the technical elements and the evaluation result. This enables the computer system to internally transform unstructured user input and heterogeneous legal and technical data into structured, cross-linked analysis target information, to leverage the generative AI model as a controlled computational component within a multi-stage data-processing pipeline, and to output machine-actionable, routed evaluation result information, thereby improving the efficiency and technical performance of the underlying computing architecture for intellectual property risk assessment.

The term “user terminal” refers to an information processing apparatus operated by a user, such as a portable terminal, a desktop terminal, or another electronic device having an input unit, a display unit, a communication unit, and a processor, and configured to transmit input information to a server and to receive and present output information from the server.

The term “input information” refers to data transmitted from a user terminal to a server and including at least one technical element related to a new function, and optionally additional context such as target use cases, target jurisdictions, or other parameters used for search and analysis.

The term “technical elements” refers to descriptions of functional features, structural features, processing steps, or other technical characteristics that define a new function or technology to be evaluated with respect to intellectual property rights.

The term “new function” refers to a technical feature, combination of features, or system behavior that is planned, designed, or implemented by a user and for which an assessment of intellectual property right infringement risk is to be performed.

The term “structured search information” refers to information generated by a processor by normalizing, expanding, and organizing input information, the structured search information including technical elements, synonyms, related terms, and optionally categorized or weighted terms suitable for use as a search query for one or more information storage devices.

The term “synonyms and related terms” refers to alternative expressions, equivalent terms, broader terms, narrower terms, or semantically similar terms corresponding to a given technical element, which are used to increase recall and semantic coverage in subsequent searches.

The term “first information storage device” refers to a storage apparatus or storage service, such as a database system or an index system, configured to store patent information and respond to search requests specifying search conditions.

The term “second information storage device” refers to a storage apparatus or storage service, such as a database system or an index system, configured to store statute information or case law information and to respond to search requests that may be based on patent information, legal topics, or other legal identifiers.

The term “patent information” refers to information relating to intellectual property rights for inventions, including at least patent identifiers, titles, abstracts, claims, classifications, filing dates, and bibliographic data stored in the first information storage device.

The term “statute information” refers to information relating to legal provisions, regulations, or rules, including statutory texts and associated metadata, stored in the second information storage device.

The term “case law information” refers to information relating to judicial decisions or administrative decisions, including case identifiers, parties, jurisdictions, dates, issues, holdings, and reasoning, stored in the second information storage device.

The term “analysis target information” refers to information generated by a processor by summarizing and integrating input information, patent information, and statute information or case law information, and used as a basis for analysis by a generative AI model.

The term “prompt sentence” refers to a text or sequence of tokens generated by a processor and provided as input to a generative AI model, the prompt sentence including at least the analysis target information and instructions or analysis content that direct the generative AI model to perform a specific evaluation or generation task.

The term “generative AI model” refers to a machine-learned model, such as a neural network-based language model, configured to generate output information, including text or structured data, in response to input tokens based on statistical patterns learned from training data.

The term “output information” refers to information generated by a generative AI model in response to a prompt sentence, the output information including at least an evaluation result relating to intellectual property right infringement risk and optionally additional explanatory or recommendation content.

The term “intellectual property right infringement risk” refers to a likelihood, degree, or possibility that implementation or use of a new function would fall within a scope of protection defined by one or more intellectual property rights, such as patent rights, and thereby constitute an infringement or potential infringement.

The term “evaluation result” refers to a result generated by a generative AI model or a processor, indicating an assessment of intellectual property right infringement risk, and optionally including associated reasons, references, and confidence levels.

The term “quantitative or qualitative evaluation index” refers to a representation format for an evaluation result, including numeric scores, scales, levels, labels, rankings, or categories that express the magnitude or classification of intellectual property right infringement risk.

The term “evaluation result information” refers to information generated by a processor by mapping an evaluation result to a quantitative or qualitative evaluation index and associating the mapped result with related patent information and statute information or case law information.

The term “design change candidate information” refers to information generated by a processor that includes one or more proposals for modification, redesign, or alternative implementation of components of a new function, the proposals being intended to reduce or avoid intellectual property right infringement risk.

The term “organizational category” refers to a classification representing a structural division within an organization, such as a department, team, or functional group, used to determine a destination for notification or processing of evaluation result information.

The term “business process category” refers to a classification representing a type of business activity or workflow, such as development, legal review, or compliance, used to determine routing or handling of evaluation result information within an organization.

The term “classification information” refers to data generated by a processor that associates technical elements and evaluation results with at least one organizational category or business process category for use in routing evaluation result information.

The term “notification destination information” refers to data indicating at least one destination, such as a responsible division, role, or terminal, to which evaluation result information is to be transmitted based on classification information.

The term “user terminal” refers to an information processing apparatus having a communication function and a user interface, configured to transmit input information to a server, to receive evaluation result information from the server, and to present the evaluation result information to a user.

The term “server” refers to an information processing apparatus or system, typically including at least one processor, memory, and communication interface, and configured to perform operations including receiving input information, accessing information storage devices, constructing prompt sentences, interacting with a generative AI model, and generating evaluation result information.

In one embodiment, a server cooperates with one or more terminals operated by users to implement an automated intellectual property right infringement risk evaluation system. The server includes at least one processor, a main memory, non-volatile storage, and a network interface. The server executes an operating system such as a general-purpose server operating system and middleware such as a web application framework (for example, a framework of the type of Python Django or Node.js Express), and exposes an application programming interface (API) over a network. The terminal may be a smartphone, a tablet, or a personal computer executing a web browser or a native application framework (for example, an application of the type of React-based web client, or a mobile client written in a general mobile development environment).

The user uses the terminal to access a graphical user interface provided by the server. The terminal displays input fields for entering technical elements of a new function, such as functional modules, data flows, algorithmic features, or hardware configurations. The terminal includes an input unit, a display unit, and a communication unit. The terminal converts user entries into structured input information and transmits the input information to the server via a network using a transport protocol such as HTTPS. By implementing the input capture and display on the terminal, network traffic is confined to compact structured messages rather than transmitting unstructured documents, which reduces communication load and improves responsiveness.

The server receives the input information and stores it temporarily in a memory-resident data structure, such as a key-value structure or a document structure held in main memory or in a fast-access data store. The server parses the input information to extract individual technical elements. The server then uses a text processing component implemented with a library of the type of spaCy or NLTK to tokenize, lemmatize, and normalize the technical elements. The server uses a synonym repository and a vector-based similarity model to expand the technical elements into synonyms and related terms. In one implementation, the server computes vector representations of technical phrases by using an embedding model of the type of Sentence-BERT, and retrieves nearest-neighbor terms from a pre-computed embedding index stored in a vector database such as a FAISS-based index.

By representing technical elements as vectors and performing nearest-neighbor searches in a compressed high-dimensional space, the server reduces redundant keyword combinations and avoids exhaustive string matching. This improves processing speed and reduces memory accesses compared to simple keyword expansion. The server generates structured search information as a composite data structure that associates each normalized technical element with a set of synonyms, related terms, and weights. The structured search information is, for example, stored as a nested list or tree structure in memory, and is later converted into query expressions for external data sources.

The server accesses a first information storage device that stores patent information and a second information storage device that stores statute information and case law information. Each information storage device may be implemented by an external database service or an internal indexing engine such as an engine of the type of Elasticsearch or a relational database management system. The server converts the structured search information into a query expression optimized for each information storage device. For example, the server constructs a Boolean query with weighted clauses for the first storage device and a topic-oriented query with legal subject tags for the second storage device.

The server executes the queries through the network interface, and the information storage devices return patent information and statute or case law information matching the queries. The server normalizes the returned records into an internal representation that separates identifiers, titles, abstracts, claims, classification codes, statutory sections, case names, holdings, and reasoning passages. The server stores these records in an in-memory cache and, if necessary, in a persistent data store such as a relational data store. The server further computes semantic relevance scores between the returned records and the technical elements by encoding textual fields using the embedding model and computing similarity metrics such as cosine similarity. This ranking stage enables the server to limit later processing to a top-ranked subset of records, reducing computational load and improving latency.

The server summarizes and integrates the input information, the patent information, and the statute or case law information into analysis target information. In one implementation, the server deploys a smaller, specialized summarization model, such as a transformer-based encoder-decoder network fine-tuned on legal and technical abstracts, to compress long patent claims and case reasoning into concise summaries. The server enforces a maximum token length for each summary to ensure that the total size of the analysis target information fits within a token budget suitable for a larger generative AI model. The server structures the analysis target information in a deterministic order: first, a normalized list of technical elements; second, a ranked list of patent summaries; and third, a ranked list of case and statute summaries. This deterministic structure improves caching efficiency and enables repeated calls to the generative AI model to reuse common portions of the context.

The server then generates a prompt sentence for a generative AI model. The server constructs the prompt sentence as a textual sequence that interleaves the analysis target information with explicit instructions defining the evaluation task and the desired output format. In one example, the server generates a prompt sentence of the following form:

You are a legal-technology assistant specialized in evaluating patent infringement risk for new technical functions.

### Technical Elements of the New Function:

face recognition for user authentication on a mobile device
payment processing linked to a credit card or digital wallet
security mechanisms including liveness detection and encrypted token transmission

### Relevant Patent Summaries:

1. Patent P1—“Face recognition payment system”
Key claims:
   Capturing a facial image via a mobile device camera;
   Comparing the image with a stored facial template on the device;
   Authorizing a payment transaction when the comparison score exceeds a threshold.

2. Patent P2—“Biometric-based transaction authorization”
Key claims:
   Receiving biometric data including facial features;
   Generating a one-time transaction token upon successful verification;
   Transmitting the token to a payment server.

### Relevant Case-Law Summaries:

1. Case C1
Issue: Whether a mobile payment application infringed a biometric authentication patent.
Holding: Infringement found where all key biometric verification and payment steps were implemented.
Relevance: Indicates how similarity of biometric payment flows is evaluated.

### Task:

1. Identify which patents and cases are most relevant to the new function.
2. Evaluate the overall patent infringement risk (Low/Medium/High).
3. Explain the reasoning, referring explicitly to patent claim elements and case-law reasoning.
4. Propose concrete design changes or design-around strategies that may reduce the risk.

### Output:

Provide a structured explanation that clearly separates risk level, key references, reasoning, and design suggestions.

The server may vary the wording of the prompt sentence depending on jurisdiction, type of intellectual property, or user preferences, but maintains a stable structure so that later parsing of the model output is deterministic.

The server connects to a generative AI model that is deployed either as a cloud-based model service or as an on-premise model. In one embodiment, the generative AI model is a large-scale transformer-based neural network with multiple layers of self-attention and feed-forward units. The model is trained using a corpus that combines general language data and domain-specific legal and technical texts. The server stores model configuration parameters such as number of layers, hidden dimension size, attention head count, and vocabulary size, and uses these parameters to determine a maximum safe input length and output length.

The generative AI model is configured through a fine-tuning process in which the model learns to map structured legal-technical contexts to risk evaluations. The training employs a supervised learning objective with a loss function such as a cross-entropy loss on token sequences combined with an auxiliary loss on discrete risk labels (for example, Low, Medium, High). During fine-tuning, the model parameters (weights in attention matrices and feed-forward layers) are updated via gradient descent with an optimization algorithm of the type of Adam. The training data include annotated pairs of prompt sentences and target outputs where experts have identified risk levels, key patents, key cases, and recommended design changes. The model thereby acquires a rule-like internal representation of how combinations of technical elements, claim language, and case reasoning correspond to infringement risk assessments.

The server invokes the generative AI model by converting the prompt sentence into tokens, transmitting those tokens to the model execution environment (for example, a GPU-equipped node with processors of the type of general-purpose graphics processing units), and reading the output sequence of tokens produced by the model. The model calculates attention scores between tokens representing technical elements and tokens representing claim elements and legal reasoning, and uses those scores to generate evaluations that are more precise than simple keyword overlap. Because the model operates on a compressed vector representation of the entire context, the server can compute complex similarity relationships in a single forward pass, which is significantly faster and more memory-efficient than separate human-designed rules or multiple database joins.

The server receives the output sequence and reconstructs text representing an evaluation result and associated reasoning. The server then post-processes the output. The server uses a rule-based parser and, optionally, a secondary smaller model to identify segments that denote a risk level, segments that reference specific patents and cases, and segments that contain design change suggestions. The server maps textual labels such as “Low risk” or “Medium risk” to predefined numeric indices and stores them as evaluation result information in a structured record. The server associates these records with identifiers of the underlying patent and legal documents, as well as the input technical elements. This structured storage enables fast retrieval and aggregation across multiple evaluations.

In one embodiment, the server generates design change candidate information by directing the generative AI model to output explicit modifications to the technical architecture of the new function, such as changing the location of biometric template storage, altering encryption algorithms, or adjusting authentication flows. The server filters suggested changes using rule-based constraints that enforce compliance with system design guidelines or applicable technical standards. The server then transmits both the evaluation result information and the filtered design change candidate information to the terminal. The terminal displays the information in a layout that visually highlights risk levels and indicates which technical elements are most sensitive. This aids the user in making targeted technical modifications rather than manually interpreting long legal documents.

The server may generate classification information that maps each evaluation result to an organizational category or business process category. For example, the server may use a simple classifier implemented as a shallow neural network or a decision-tree model that takes as input features such as risk level index, technology domain tags, and jurisdiction tags, and outputs a category code corresponding to development, legal, or compliance workflows. Using this category code, the server determines notification destination information identifying terminals associated with specific roles inside an organization. The server automatically forwards evaluation result information to these terminals, thereby integrating the risk evaluation into existing version control systems, project management systems, or issue tracking systems.

The described configuration improves computer technology in several ways. First, by representing technical elements and legal texts as vector embeddings and operating with nearest-neighbor searches and transformer-based attention, the server performs semantic matching in compressed spaces that reduce memory footprint and accelerate retrieval, particularly when the number of documents is large. Second, by enforcing token budgets, structured summaries, and deterministic prompt layouts, the server reduces network bandwidth to generative AI services and maximizes cache reuse, resulting in lower latency and improved throughput. Third, by converting unstructured model outputs into structured evaluation result information and classification information, the server enables downstream automated routing and aggregation without human intervention, which reduces error rates and avoids repeated manual interpretation of outputs.

Moreover, the system uses non-conventional processing sequences and data structures that differ from simple automation of human workflows. A human expert typically reads documents sequentially and applies implicit legal reasoning. In contrast, the server applies a multi-stage pipeline that first encodes all relevant data into normalized vector spaces, then performs ranked selection, structured summarization, controlled prompt construction, and model-guided evaluation with explicit mapping to quantitative indices. This non-human processing path, optimized for the architecture of neural networks and modern databases, produces technical effects such as faster convergence to relevant references, reduction of irrelevant retrievals, and more stable model behavior due to controlled context shaping.

In alternative embodiments, the generative AI model may be replaced or augmented by other machine-learned models, such as a mixture-of-experts architecture in which specialized sub-models handle particular technology domains, or by hybrid models that combine rule-based legal reasoning with neural text generation. The server may also vary the underlying database technology, such as using a document store for patent information and a graph database for case law information, while preserving the same overall pipeline of structured search information generation, analysis target information assembly, prompt sentence construction, generative AI inference, and evaluation result information synthesis.

In all such embodiments, the server, the terminal, and the user interact in a coordinated manner so that the system can be practically implemented. The user operates the terminal to provide technical elements and to receive detailed, structured guidance. The terminal performs user interface functions and data transmission. The server performs concrete, technically detailed data transformations, model invocations, and routing operations that improve computer performance in terms of speed, accuracy, data management, and communication efficiency, thereby enabling others skilled in the art to implement and utilize the invention.

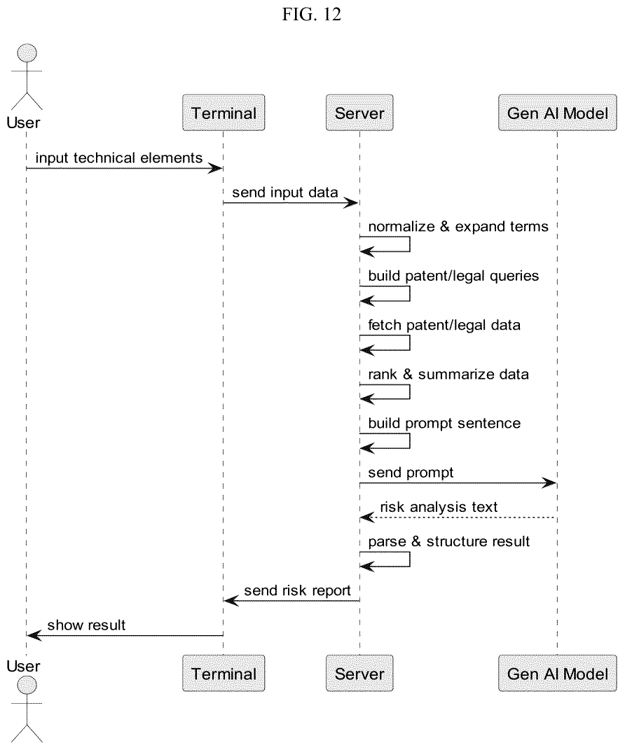

The following describes the processing flow using FIG. 12.

### Step 1:

User operates the terminal to access a risk evaluation interface and to input technical elements of a new function.
User enters one or more textual descriptions such as “face recognition,” “payment processing,” and “security mechanisms” into input fields displayed on the terminal.
Terminal takes, as input, the raw text strings entered by the user and metadata such as target jurisdiction or project identifier.
Terminal performs basic validation (for example, checking that required fields are not empty and that text length is within limits), converts the text into a structured format (such as an internal object containing a list of technical elements and optional attributes), and outputs structured input information.
Terminal transmits the structured input information to the server over a network using a protocol such as HTTPS.

### Step 2:

Server receives the structured input information from the terminal.
Server takes, as input, the structured input information including the list of technical elements and optional metadata.
Server parses the input information, normalizes character encoding, removes leading and trailing spaces, converts letters to a canonical case (for example, lower case), and splits compound phrases into individual tokens using a tokenizer of the type of spaCy or NLTK.
Server generates, as output, a normalized technical element list and a tokenized representation of each element, and stores these in a memory-resident data structure for subsequent processing.

### Step 3:

Server generates an expanded representation of the technical elements by adding synonyms and related terms.
Server takes, as input, the normalized technical element list and the tokenized representation from Step 2.
Server queries a synonym repository and computes vector embeddings for each technical element using an embedding model of the type of Sentence-BERT.
Server performs a nearest-neighbor search in an embedding index (for example, a FAISS-based index) to find semantically similar terms within a specified similarity threshold.
Server filters candidate terms based on part-of-speech tags and domain-specific stop-word rules so that only technically relevant synonyms and related terms are kept.
Server outputs structured search information, which associates each original technical element with a list of synonyms, related terms, and optional weights indicating relative importance, and stores this structured search information in memory.

### Step 4:

Server prepares and issues search queries to a first information storage device that stores patent information.
Server takes, as input, the structured search information generated in Step 3.
Server converts the structured search information into a query expression suitable for the patent storage device, for example, by constructing a Boolean expression of the form (face recognition OR facial recognition OR biometric authentication) AND (payment OR transaction) AND (security OR encryption).
Server sends this query expression via an API client to the first information storage device, which may be implemented by a patent database or a search engine of the type of Elasticsearch.
Server receives, as output, patent information records containing identifiers, titles, abstracts, claims, and classification codes, and stores these records in a temporary patent result set in memory or a fast-access data store.

### Step 5:

Server analyzes the retrieved patent information and prepares search queries for a second information storage device that stores statute and case law information.
Server takes, as input, the temporary patent result set from Step 4 and the original normalized technical element list from Step 2.
Server extracts key legal topics and identifiers from the patent information, for example, by scanning claims and abstracts for phrases such as “method for authentication” and “transaction authorization” and by extracting cited statutes or case references.
Server constructs topic features and identifiers and combines them with technical elements to form a composite legal-technical query profile.
Server generates, as output, one or more query expressions and topic vectors to be used for searching statute and case law information in the second information storage device.

### Step 6:

Server searches the second information storage device for relevant statute and case law information.
Server takes, as input, the query expressions and topic vectors from Step 5.
Server sends these queries to the second information storage device, which may be implemented as a legal text database, a relational database, or a search engine.
Server receives, as output, a set of statute information and case law information records, each including identifiers, jurisdiction, sections, headnotes, holdings, and reasoning passages.
Server normalizes the received records into an internal schema and stores them in an in-memory legal result set associated with the corresponding technical elements and patent records.

### Step 7:

Server ranks and selects the most relevant patent and legal records.
Server takes, as input, the temporary patent result set and the legal result set from Steps 4 and 6, along with the normalized technical elements.
Server encodes titles, abstracts, claim segments, and legal reasoning passages into vector embeddings using the same or a compatible embedding model as in Step 3.
Server computes similarity scores, for example, cosine similarity, between embeddings of technical elements and embeddings of each patent and legal record.
Server aggregates scores across multiple fields (for example, claim field and abstract field) using a weighted sum and sorts records in descending order of relevance.
Server outputs a ranked list of patent records and a ranked list of legal records and selects a top-k subset (for example, top 10 patents and top 5 legal records) for further processing.

### Step 8:

Server summarizes and integrates technical, patent, and legal information into analysis target information.
Server takes, as input, the normalized technical elements from Step 2 and the top-ranked patent and legal records from Step 7.
Server applies a summarization component, which may be a transformer-based encoder-decoder network fine-tuned on legal and technical text, to compress long claim sets and reasoning passages into short summaries constrained by a token limit.
Server concatenates the technical elements, patent summaries, and legal summaries into a structured text representation with a predetermined order and labels, such as sections labeled “Technical Elements,” “Patent Summaries,” and “Case Law Summaries.”
Server produces, as output, analysis target information in textual form, ready to be embedded within a prompt sentence.

### Step 9:

Server constructs a prompt sentence for a generative AI model using the analysis target information.
Server takes, as input, the analysis target information from Step 8 and rules that define a prompt template, including instructions and output format constraints.
Server inserts the analysis target information into designated sections of the prompt template, and adds task instructions such as “identify most relevant patents and cases,” “evaluate risk level,” and “propose design changes.”
Server ensures that the total token length is within a limit appropriate for the generative AI model by truncating or further compressing portions of the analysis target information when necessary.
Server generates, as output, a complete prompt sentence in natural language, designed for input to the generative AI model.

### Step 10:

Server submits the prompt sentence to the generative AI model and obtains model output.
Server takes, as input, the prompt sentence generated in Step 9 and model configuration parameters, such as temperature, maximum output tokens, and decoding strategy.
Server converts the prompt sentence into tokens using a tokenizer associated with the generative AI model and sends the token sequence to the model executed on a hardware platform, for example, a GPU-equipped node.
Server receives, as output, a token sequence produced by the model, representing an evaluation of intellectual property right infringement risk, references to key documents, and design change suggestions.
Server decodes the token sequence into text, thereby obtaining raw output information from the generative AI model.

### Step 11:

Server parses and structures the model output into evaluation result information.
Server takes, as input, the raw output text from Step 10.
Server applies a parser that searches for predefined markers or section headers in the text, such as “Risk Level:”, “Key Patents:”, “Key Cases:”, “Reasoning:”, and “Design Suggestions:”.
Server extracts the content of each section and maps textual risk labels (for example, “Low,” “Medium,” “High”) to numeric indices or coded values.
Server associates each referenced patent or legal case in the output with corresponding identifiers in the internal patent and legal result sets.
Server generates, as output, evaluation result information, which includes structured fields for risk level, linked patents, linked cases, reasoning text, and design change candidate information.

### Step 12:

Server generates routing and notification information based on the evaluation result information.
Server takes, as input, the evaluation result information from Step 11 and the original metadata (for example, project identifier, organizational context) from Step 1.
Server computes classification information by applying a classifier or rule set that considers features such as risk level, technology domain, and jurisdiction to determine an organizational category or business process category.
Server then determines notification destination information by mapping the category to specific roles or divisions and identifying associated terminals or endpoints.
Server outputs routing information that includes the evaluation result information and the notification destination information.

### Step 13:

Server transmits evaluation result information and, if present, design change candidate information to the appropriate terminals.
Server takes, as input, the routing information from Step 12.
Server formats the evaluation result information into response messages tailored for terminal display, for example, by structuring fields into a concise response format and truncating excessively long text while preserving essential content.
Server sends response messages to the original user terminal and, where specified by the routing information, to additional terminals associated with responsible divisions or roles.
Server outputs network responses containing the evaluation result information, which are delivered over the network.

### Step 14:

Terminal receives and presents the evaluation result information to the user.
Terminal takes, as input, the response messages sent by the server in Step 13.
Terminal parses the messages to extract risk levels, lists of key patents and cases, reasoning text, and design change candidate information.
Terminal updates its user interface to display the risk level, highlights technical elements associated with higher risk, and presents links or summaries for key patents and cases, as well as proposed design changes.
User reviews the displayed information, and based on the structured evaluation and suggestions, user may decide to modify the new function, request further analysis, or initiate follow-up actions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional intellectual property risk assessment systems mainly rely on simple keyword search engines and rule-based scoring logic executed by general-purpose processors. In such systems, a server typically retrieves large sets of patent documents from multiple databases and applies static filters or manually defined heuristics to approximate similarity between a target technology description and existing claims. Because these approaches operate on shallow text matching and rigid rules, they often fail to capture the substantive technical overlap between inventions, resulting in inconsistent and low-granularity infringement risk evaluations. Furthermore, when naïve ve integration of a generative AI model is attempted, the model is usually invoked as a black-box question-answering tool that directly processes unfiltered document corpora. This leads to excessive computational load, unstable outputs, and difficulty in reproducing or validating individual risk determinations.

In addition, known systems do not effectively structure the interaction between vector-based similarity computation and generative AI reasoning. Patent texts and target technology descriptions are commonly passed to the model without prior vector embedding, without candidate narrowing based on numerical similarity, and without systematic transformation of qualitative model outputs into machine-aggregatable numerical risk values. As a result, the underlying computer system performs redundant inference over large, noisy input contexts, incurs unnecessary latency and resource consumption, and produces results that are difficult to rank, compare, or integrate into downstream workflows such as automated reporting or portfolio management.

Moreover, report generation in existing tools tends to be a post hoc, manual or semi-manual process. A human expert must reconcile disparate outputs from search engines, analytic scripts, and generative models, then draft a narrative document and structured summary. This workflow not only increases turnaround time and cost but also prevents the server from being optimized end-to-end as a coherent data-processing pipeline, in which each stage is designed to transform data into progressively more structured and computable forms.

Accordingly, there is a need for a computer-implemented system that technically improves the functioning of a server in performing intellectual property risk analysis. Specifically, there is a need for a system that (i) uses vector embedding to pre-select and compress relevant claim sets before invoking a generative AI model, (ii) constructs prompt sentences in a structured, size-controlled manner tailored to the model's context constraints, (iii) parses the generative AI output into normalized structured information, and (iv) converts such structured information into numerical risk evaluation values that can be aggregated and rendered into machine-generated reports. By tightly coupling embedding-based filtering, prompt engineering, structured parsing, and automated report generation within a single processor-controlled pipeline, the server can reduce computational overhead, improve determinism and reproducibility of the analysis, and enhance the quality and usability of the infringement risk evaluation produced to the user's terminal.

The specific processing by the specific processing unit 290 of the data processing device 12 in Example 2 is realized by the following means.

The present invention provides a server comprising a processor configured to receive, from a terminal, target technology information and search condition information, to set intellectual property information and regulation information stored in a plurality of storage devices as search targets based on the target technology information, to acquire document information from the intellectual property information set as the search targets, to perform preprocessing on the document information using natural language processing techniques and similarity calculation techniques so as to convert the document information into a format inputtable to a generative information processing model, to generate a prompt sentence including the target technology information and claim information selected based on relevance, to input the prompt sentence to the generative information processing model and obtain structured analysis result information including similarity information and risk level information, to convert the similarity information and the risk level information into numerical information and aggregate the numerical information to calculate an infringement risk evaluation value for the target technology information, and to generate and transmit, to the terminal, an evaluation result document including ranked intellectual property information and explanation information based on the infringement risk evaluation value. This enables the server to technically improve computer processing for intellectual property risk assessment by reducing the amount of data supplied to the generative AI model, by structuring inputs and outputs of the model for deterministic computation, by transforming qualitative model responses into quantitative risk scores, and by automatically producing machine-generated reports with consistent, reproducible infringement risk evaluations.

The term “processor” refers to a hardware or virtual computing element, such as a central processing unit, graphics processing unit, or programmable logic circuit, that executes machine-readable instructions to perform data processing operations.

The term “terminal” refers to an information processing apparatus, such as a personal computer, mobile device, or network-connected client device, that transmits input information to the server and receives output information from the server via a communication network.

The term “target technology information” refers to descriptive information, expressed in natural language or structured form, that specifies a technology, product, or process for which intellectual property infringement risk is to be evaluated.

The term “search condition information” refers to control information defining constraints or parameters for retrieving intellectual property information, including, for example, keywords, classification codes, time periods, jurisdictions, assignees, or document types.

The term “information storage device” refers to a physical or logical storage resource, such as a database system, file system, or cloud storage service, that stores intellectual property information and regulation information accessible by the processor.

The term “intellectual property information” refers to information relating to intellectual property rights, including, for example, patent documents, patent applications, published patent literature, or other right-related records and their associated metadata.

The term “regulation information” refers to information representing legal norms relevant to intellectual property, including, for example, statutes, rules, guidelines, case law summaries, and regulatory provisions stored in a retrievable format.

The term “document information” refers to textual content and associated structural data extracted from intellectual property information, including, for example, titles, abstracts, descriptions, and claims of intellectual property documents.

The term “natural language processing techniques” refers to computational methods for analyzing, transforming, or understanding text expressed in human language, including, for example, tokenization, part-of-speech tagging, parsing, entity recognition, and text normalization.

The term “similarity calculation techniques” refers to computational methods for measuring relatedness between pieces of information, including, for example, vector-based similarity, keyword-based similarity, or statistical similarity metrics.

The term “generative information processing model” refers to a machine learning model, such as a generative AI model, that receives input data and produces text or structured output by learning probabilistic relationships from training data.

The term “prompt sentence” refers to an input sequence, including instructions, context, and data content, that is supplied to a generative information processing model to cause the model to generate analysis result information.

The term “analysis result information” refers to output information generated by the generative information processing model in response to a prompt sentence, including, for example, identified correspondences, similarity assessments, and risk indications.

The term “structured information” refers to data organized in a predefined schema, such as key-value pairs, records, or tables, that enables deterministic parsing, computation, and aggregation by the processor.

The term “similarity information” refers to information indicating a degree of relatedness or correspondence between the target technology information and claim information, expressed qualitatively or quantitatively.

The term “risk level information” refers to information indicating an estimated magnitude or category of intellectual property infringement risk, such as low, medium, or high, associated with the target technology information.

The term “numerical information” refers to data represented as numbers, including scores, indices, or weights, which are suitable for arithmetic operations and aggregation by the processor.

The term “infringement risk evaluation value” refers to a numerical indicator, computed by the processor, that quantifies a likelihood or degree of intellectual property infringement associated with the target technology information.

The term “evaluation result document” refers to a document generated by the processor that includes at least the infringement risk evaluation value, related intellectual property information, and explanation information in a human-readable or machine-readable form.

The term “embedding process” refers to a computation that converts text or other symbolic data into numerical vector information in a continuous vector space suitable for similarity measurement.

The term “numerical vector information” refers to an ordered set of numerical values representing an embedded form of text or other data, which can be processed by similarity calculation techniques.

The term “candidate set of the claim information” refers to a subset of claim information selected by the processor based on similarity calculations as being relatively more relevant to the target technology information.

The term “rank” refers to an operation of ordering multiple pieces of intellectual property information according to a criterion, such as the infringement risk evaluation value, to determine a relative ordering.

The term “overlapping technical element information” refers to information specifying technical features or elements that are common to both the target technology information and the claim information.

The term “reason explanation information” refers to textual or structured information that describes grounds or rationale for an assigned risk level, ranking, or correspondence determination.

The term “report document format” refers to a predefined layout or structure for presenting evaluation results, including, for example, headings, sections, tables, and fields suitable for human review.

The term “file” refers to a data object stored in a storage medium, representing at least one evaluation result document in a given report document format, which can be transmitted to and displayed by a terminal.

In one embodiment, a server implements an intellectual property risk evaluation system using a combination of general-purpose computing hardware, specialized software libraries, and a neural-network-based generative AI model. The server includes at least one processor, a main memory, a nonvolatile storage device, and a network interface. The processor is, for example, a multi-core x86-compatible central processing unit, optionally combined with a graphics processing unit that supports general-purpose computation. The main memory stores executable programs and intermediate data structures during operation. The nonvolatile storage device stores a relational database, an index of intellectual property documents, a repository of legal texts, and configuration data. The network interface connects the server to one or more terminals operated by users via a communication network such as the Internet.

The server executes an operating system such as a general-purpose server operating system, and executes middleware including a database management system (for example, a relational database engine), a search engine (for example, a full-text search engine that implements an inverted index and BM25 ranking), and an application runtime environment (for example, an interpreter or virtual machine for a high-level programming language). The server further executes software modules that implement natural language processing using a library such as a tokenization and parsing toolkit, and that implement vector embedding using a machine learning framework such as a tensor computation library.

The terminal is, for example, a personal computer, a tablet device, or a smartphone. The terminal executes a web browser or native application that provides a graphical user interface. The user operates the terminal to input target technology information and search condition information. The terminal sends these inputs to the server over a secure transport protocol, and receives evaluation result documents from the server for display on a screen or for storage.

The user operates the terminal to enter a natural language description of a technology to be evaluated. For example, the user may input:

“A non-invasive blood glucose monitoring device using near-infrared light to estimate glucose concentration from reflected light on a patient's skin, with a machine-learning-based signal processing algorithm that corrects for skin tone and tissue thickness.”

The user may also specify search conditions such as relevant technical fields, time ranges, and jurisdictions. The terminal encodes these inputs into a structured data format, associates them with a user identifier, and transmits them to the server.

The server stores the received target technology information and search condition information in the database using structured records. The server accesses one or more information storage devices that store intellectual property information and regulation information. In one embodiment, the intellectual property information is stored as structured records containing bibliographic data fields (such as publication number, filing date, and assignee) and full-text fields (such as title, abstract, description, and claims). The regulation information is stored as text sections corresponding to statutory provisions and guidelines.

The server uses a full-text search engine to retrieve document information from the intellectual property information based on the target technology information and search condition information. The search engine maintains an inverted index of term occurrences, and the server uses scoring functions such as BM25 or term frequency-inverse document frequency to identify a candidate set of documents. The server then extracts document information including claim texts and descriptive passages from the retrieved documents.

The server applies natural language processing techniques to the document information and the target technology information. The server performs tokenization to split text into tokens, part-of-speech tagging to identify grammatical categories, and syntactic parsing to identify phrase boundaries. The server optionally performs named-entity recognition to detect technical components, measurement units, materials, and functional verbs. These processes are implemented using a natural language processing library that is executed by the processor.

The server constructs feature vectors representing the target technology information and the document information using an embedding process. In one embodiment, the server uses a transformer-based neural network trained on a large corpus of technical text. The neural network includes multiple attention layers, each layer performing self-attention with learned query, key, and value projections. The server passes tokenized text through an embedding layer, positional encoding, and a stack of attention layers to obtain a contextualized vector representation at the sequence level. The server extracts a pooled vector (for example, by averaging token embeddings or by using a special classification token position) as numerical vector information for each piece of text.

The server calculates similarity between numerical vector information of the target technology information and numerical vector information of individual claims and passages using a similarity calculation technique such as cosine similarity. For each piece of claim information, the server computes a normalized similarity score between 0 and 1. The server selects a candidate set of claim information by applying a similarity threshold or by selecting a fixed number of top-ranked claims. This candidate set becomes the basis for subsequent generative AI processing. By performing this numerical filtering before invoking the generative AI model, the server reduces the amount of text passed into the model, increases processing speed, and decreases memory consumption on the model-serving hardware.

The server generates a prompt sentence that is supplied to the generative AI model. The server constructs the prompt sentence by concatenating: (i) an instruction section that describes the analysis task; (ii) a structured restatement of the target technology information; and (iii) representative claim texts from the candidate set. The server formats the prompt sentence in natural language and imposes an order and labeling scheme that support reliable parsing of the model's output. For example, the server may generate a prompt sentence such as:
“You are an intellectual property analysis assistant.
Task: Evaluate the patent infringement risk of the following new technology by comparing it with existing patent claims.

### New Technology:

A non-invasive blood glucose monitoring sensor using near-infrared (NIR) light to estimate glucose levels from reflected light on a patient's skin. The device includes an NIR light source, a photodetector array, and a machine-learning-based signal processing algorithm that corrects for skin tone and tissue thickness.

### Candidate Patent Claims:

[1] Patent A, Claim 1. A non-invasive measurement apparatus comprising an infrared light emitter configured to irradiate tissue of a subject, a photodetector configured to receive reflected infrared light, and a computation unit configured to estimate blood analyte concentration based on calibration data.
[2] Patent B, Claim 5: A method for estimating a physiological parameter, the method comprising irradiating skin with optical radiation and processing received signals using a trained neural network model.

### Please:

(1) Identify which candidate claims are most similar to the new technology.
(2) List overlapping technical elements between the new technology and each similar claim.
(3) For each similar claim, assess the likelihood of infringement as low, medium, or high, and explain the reasons.
(4) Provide an overall infringement risk assessment for the new technology as low, medium, or high, with a short justification.”

The server ensures that the length of the prompt sentence does not exceed the context capacity of the generative AI model by truncating or summarizing long claim texts when necessary. The server may use a separate summarization model, which is another transformer network trained to compress long sequences, to generate concise summaries of lengthy descriptions. By using structured prompt sentences and pre-summarized content, the server reduces communication bandwidth between the application layer and the model-serving layer, and improves response time.

The server interacts with a generative information processing model that is implemented as a neural network with multiple transformer layers. The model has been trained on large-scale text data using a supervised or self-supervised learning method. During training, the model receives input token sequences and predicts subsequent tokens, minimizing prediction error using a loss function such as cross-entropy. The model parameters, including weight matrices in attention layers and feed-forward layers, are updated using gradient-based optimization algorithms such as stochastic gradient descent with momentum or adaptive moment estimation. Training may include techniques such as learning rate scheduling, dropout regularization, and data augmentation by rephrasing or masking segments of text.

At inference time, the server supplies the prompt sentence to the generative AI model via an application programming interface. The model converts tokens into vector representations, applies attention operations across multiple layers to compute contextualized representations, and then decodes the next tokens to produce output text. The server configures inference parameters such as temperature, maximum output length, and deterministic decoding strategy (for example, greedy decoding or beam search with small beam width) to stabilize responses and reduce randomness.

The server receives the output text from the generative AI model as analysis result information. The server parses the text according to the labeling scheme imposed in the prompt sentence. For example, the server may require the model to output items in a numbered list format, and may use regular expressions or rule-based parsers to extract patent identifiers, overlapping technical element descriptions, and risk level labels. The server converts qualitative risk labels such as “low,” “medium,” and “high” into numerical values. The server may, for instance, assign low to a numeric value of 20, medium to 50, and high to 80. The server multiplies these values by similarity scores derived from the embedding process, and further adjusts them based on counts of overlapping technical elements. The server thus computes an infringement risk evaluation value for each claim and for the overall technology.

The server aggregates per-claim scores to obtain per-patent scores using operations such as maximum, weighted average, or threshold-based combination. The server can also compute confidence intervals or dispersion measures by analyzing distribution of scores across claims. These computations are executed using numeric libraries that operate on arrays or tensors, thereby leveraging vectorized operations to improve computational efficiency.

The server generates an evaluation result document that includes the infringement risk evaluation value, a ranked list of relevant intellectual property information, and explanation information. The server orders the intellectual property information in descending order of risk evaluation values and constructs for each item a summary including claim identifiers, overlapping technical elements, and narrative reasons. The server formats this information into a report document format such as structured text or a markup-based layout. The server may embed tables, headings, and cross-references into the document so that the report can be easily rendered on the terminal.

The terminal receives the evaluation result document and displays it to the user. The user can inspect detailed explanations, follow links to original documents, and adjust search conditions or target technology information for repeated analysis. In some embodiments, the user can request multiple evaluations in sequence, and the server maintains a history of evaluations and associated data structures in the database.

The described arrangement improves computer technology in several ways. By performing vector embedding and similarity-based candidate selection before invoking the generative AI model, the server reduces the size of the input to the model. This reduces inference time and memory consumption, directly improving processing speed and scalability of the system. By encoding structured prompts and parsing structured outputs, the server transforms the generative model output from unstructured narrative text into machine-operable structured information, enabling deterministic numerical aggregation and ranking that conventional manual review cannot achieve. This transformation allows the server to function as an integrated pipeline, where each stage (search, embedding, prompt generation, model inference, parsing, scoring, and reporting) is optimized for computational efficiency and reproducibility.

Moreover, the server's embedding-based selection of claim information and its controlled prompt construction reduce network traffic and computational overhead compared to naïve ve approaches that send entire unfiltered document corpora to a model. This yields lower communication load between the server and the model execution environment, particularly in architectures where the generative model is hosted on a separate hardware cluster or cloud service.

The server's algorithms for converting qualitative model responses into quantitative infringement risk evaluation values provide a technical improvement in data management. The system stores risk values in normalized numerical form, together with underlying embeddings and parsing outputs, enabling fast retrieval, comparison, and aggregation across large volumes of evaluations. Conventional systems that store only narrative text explanations force human examiners to re-interpret each assessment, whereas the present system allows automated sorting, thresholding, and filtering using standard database operations.

In further embodiments, the server employs alternative neural network architectures for the embedding process, such as convolutional neural networks applied to character sequences or hybrid models combining recurrent layers with attention layers. The server may also update embedding model parameters by fine-tuning on a corpus of intellectual property documents. During such fine-tuning, the server computes a loss function based on similarity or contrastive learning objectives and updates weights using gradient descent. This adaptation improves embedding fidelity for patent-specific language, which in turn improves similarity calculation accuracy and reduces false positives and false negatives.

The server can also adapt the weighting scheme used to compute infringement risk evaluation values by training a supervised model on historical cases. For example, the server may train a logistic regression or gradient-boosted decision tree to map features such as similarity scores, number of overlapping elements, and specific technical field indicators to an overall risk probability. This training process uses labeled examples of prior infringement findings or legal opinions, and a loss function such as log-loss to adjust model parameters. The integration of such a learned mapping further improves accuracy and reduces systematic bias relative to hand-tuned rules.

In another embodiment, the server supports different output formats and levels of detail by modifying the prompt sentence. For an expert user, the server may include detailed claim language and technical element breakdowns; for a non-expert user, the server may request concise summaries and high-level risk descriptions. Because the server constructs the prompt sentence programmatically, it can adapt to different contexts while still using the same underlying embedding and parsing infrastructure.

In yet another embodiment, the server controls additional devices or subsystems based on the evaluation result. For example, in an enterprise environment, the server may interact with document management systems or workflow engines to automatically tag or route technical disclosure documents according to their computed infringement risk evaluation values. By controlling such downstream systems through interfaces and API calls, the server reduces manual routing errors and accelerates decision-making. The control operations are driven by quantitative risk measures rather than static routing rules, which leads to more consistent and technically grounded handling of documents.

By implementing these interconnected modules and data flows, the server does not merely automate a human mental process but instead enhances the operation of the computing system itself. The use of neural network embeddings, controlled prompt sentence construction, structured parsing, and numerical aggregation improves computational efficiency, data organization, and output stability over conventional keyword and rules-based systems. The combination of these elements yields technical effects such as faster processing, reduced memory usage, improved accuracy of similarity detection, and lower network and computation load, thereby providing a concrete improvement in computer technology when executing intellectual property risk evaluations using a generative AI model.

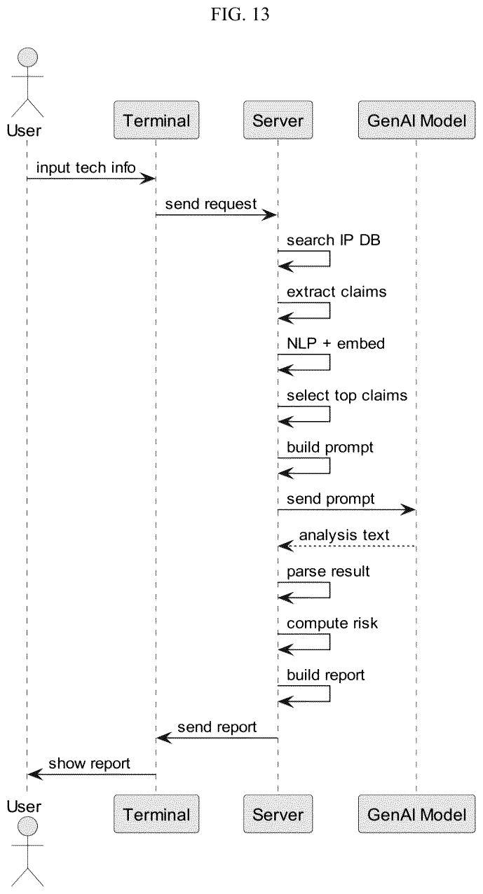

The following describes the processing flow using FIG. 13.

### Step 1:

The user operates the terminal to input target technology information and search condition information.
The terminal receives, as input, a natural language description of a target technology (for example, text entered in a web form) and optional constraints such as jurisdictions, date ranges, and classification codes.
The terminal validates the input (for example, checks for empty required fields, normalizes character encoding) and converts the information into a structured request object including user identifier, target technology text, and search parameters.
The terminal outputs the structured request object and transmits it to the server over a network using a secure communication protocol.

### Step 2:

The server receives the structured request object from the terminal.
The server takes, as input, the user identifier, target technology text, and search parameters from the request object.
The server stores these values in a relational database as a new evaluation record, assigning a unique evaluation identifier, and logs metadata such as timestamp and client address.
The server outputs a stored evaluation record and a normalized version of the target technology text for subsequent processing.

### Step 3:

The server retrieves candidate intellectual property documents from one or more information storage devices.
The server uses, as input, the normalized target technology text and the search parameters contained in the evaluation record.
The server constructs a full-text search query (for example, a query over title, abstract, and claim fields) and submits it to a search engine that maintains an inverted index over intellectual property documents. The server then receives a ranked list of document identifiers and associated relevance scores.
The server outputs a set of candidate document identifiers and their basic metadata, and stores this set in association with the evaluation identifier.

### Step 4:

The server extracts document information including claim texts from the candidate intellectual property documents.
The server uses, as input, the candidate document identifiers and accesses the underlying document records in a database or file storage.
The server reads structured fields such as title, abstract, description, and claims; strips markup such as XML tags; and normalizes whitespace and encoding. The server may segment claims into independent and dependent claims and identify claim boundaries.
The server outputs cleaned document information, including per-claim text blocks for each candidate document.

### Step 5:

The server preprocesses the target technology text and the document information using natural language processing techniques.
The server uses, as input, the normalized target technology text and the cleaned claim texts and descriptions.
The server tokenizes each text into tokens, performs part-of-speech tagging, and applies sentence segmentation. Optionally, the server performs named-entity recognition to detect technical components, parameters, and operations. The server also removes stop words and performs lemmatization to reduce word forms to base forms.
The server outputs tokenized and annotated text representations suitable for embedding and similarity computation.

### Step 6:

The server performs an embedding process to convert texts into numerical vector information.
The server uses, as input, the tokenized target technology text and the tokenized claim texts.
The server feeds the tokens through a transformer-based neural network embedding model, which maps tokens to embedding vectors, applies multiple self-attention layers, and derives a fixed-length numerical vector for each text (for example, by pooling token vectors). This involves matrix multiplications and non-linear activation operations executed on the processor (and optionally on a graphics processing unit).
The server outputs numerical vector information for the target technology text and for each claim text.

### Step 7:

The server calculates similarity between the target technology vector and each claim vector, and selects a candidate set of claim information.
The server uses, as input, the numerical vector information produced by the embedding model.
The server computes cosine similarity or another distance-based metric between the target technology vector and each claim vector. The server then sorts claims by similarity score or applies a threshold to filter out low-similarity claims.
The server outputs a candidate set of high-similarity claim texts and their associated similarity scores for use in prompt construction.

### Step 8:

The server generates a structured representation of the target technology for inclusion in a prompt sentence.
The server uses, as input, the annotated target technology text and the extracted named entities.
The server clusters identified entities into categories such as devices, sensors, algorithms, materials, and use conditions, and formats them into bullet-point style or short declarative sentences. This involves grouping tokens by semantic labels and composing template-based text fragments.
The server outputs a structured, human-readable summary of the target technology that can be inserted into a prompt sentence.

### Step 9:

The server constructs a prompt sentence for a generative AI model using the candidate claims and the structured target technology representation.
The server uses, as input, the structured summary of the target technology, the candidate claim texts, and their similarity scores.
The server organizes these elements into an instruction-oriented prompt, including sections such as “Task,” “New technology,” and “Candidate patent claims.” The server may truncate or summarize long claim texts to satisfy a maximum token budget by invoking an auxiliary summarization function and concatenating the resulting short texts.
The server outputs a single prompt sentence or a small set of prompt sentences in natural language, ready to be sent to the generative AI model.

### Step 10:

The server sends the prompt sentence to the generative AI model and obtains analysis result information.
The server uses, as input, the constructed prompt sentence and model configuration parameters such as maximum output length and decoding strategy.
The server transmits the prompt to a model-serving endpoint via an application programming interface. The generative AI model executes neural computations on the prompt, generating output text that describes similar claims, overlapping technical features, and qualitative risk levels. The server waits for and receives the returned output text.
The server outputs raw analysis result text that includes descriptions of correspondences and risk assessments.

### Step 11:

The server parses the analysis result information into structured information.
The server uses, as input, the raw textual output produced by the generative AI model.
The server applies rule-based parsing or pattern matching, for example by detecting numbered items, labels, and specific keywords, to extract patent identifiers, claim numbers, overlapping technical elements, and risk labels such as “low,” “medium,” or “high.” The server organizes these elements into a structured data format, such as a set of records with predefined fields.
The server outputs structured information containing, for each referenced claim, its identifier, overlapping elements, and a qualitative risk label.

### Step 12:

The server converts qualitative risk labels and similarity scores into numerical infringement risk evaluation values.
The server uses, as input, the structured information from the parsing step and the similarity scores computed earlier.
The server maps each qualitative risk label to a base numeric value and combines this with the corresponding similarity score using arithmetic operations such as multiplication and weighted averaging. The server may also include additional features such as the number of overlapping elements, and compute a composite score per claim. The server then aggregates claim-level scores per patent and for the overall target technology.
The server outputs infringement risk evaluation values at the claim level, patent level, and overall technology level.

### Step 13:

The server ranks intellectual property information based on infringement risk evaluation values and prepares content for an evaluation result document.
The server uses, as input, the computed infringement risk evaluation values and the associated structured information for each document.
The server sorts the intellectual property documents by descending risk score and selects top-ranked items. For each selected item, the server composes text sections summarizing relevant claims, overlapping technical elements, and reasons for the risk level. These sections are created by combining static templates with dynamic data fields.
The server outputs an ordered list of document entries and corresponding explanatory texts to be used in report generation.

### Step 14:

The server generates an evaluation result document in a report document format.
The server uses, as input, the ordered list of document entries, explanatory texts, and overall risk scores.
The server instantiates a predefined report layout, inserts headings, tables, and narrative sections, and fills in dynamic fields such as evaluation identifier, date, and summary assessment. The server then converts the structured content into a desired file format, for example a markup-based document or a portable document format, using a formatting engine.
The server outputs a completed evaluation result document file and stores it in association with the evaluation record.

### Step 15:

The server transmits the evaluation result document to the terminal for display to the user.
The server uses, as input, the location or identifier of the generated document file and the terminal address associated with the evaluation record.
The server prepares a response message containing a link, a file stream, or a descriptor for the evaluation result document and sends this message to the terminal over the network. The terminal receives the message, downloads or opens the file, and renders the report on a display device so that the user can review the intellectual property risk evaluation.
The terminal outputs a visual representation of the evaluation result document to the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented intellectual property (IP) risk assessment tools largely operate as static search interfaces that merely forward user-entered keywords to one or more databases and then return unstructured document lists. In such systems, a processor typically does not perform deep language analysis of user technical descriptions, does not automatically generate optimized search queries, and does not coordinate interaction with a generative AI model in a closed loop. As a result, the computer system consumes substantial computational and network resources to deliver voluminous, low-relevance search results, imposes significant manual effort on human experts to interpret those results, and fails to provide machine-generated, structured risk evaluations tailored to the user's actual technical disclosure.

Furthermore, in many existing systems, the processor treats all user requests uniformly, without considering the user's emotional state or context. The system therefore cannot dynamically adjust evaluation criteria or presentation style. This lack of adaptive behavior leads to inefficient use of computation and bandwidth, as the system may generate overly detailed responses for confident users or insufficiently cautious assessments for anxious users. The computer thus does not exploit available affective signals to optimize internal processing paths, data retrieval depth, or generative AI model usage.

Additionally, conventional IP management platforms often lack an integrated mechanism in which a processor automatically: (i) derives structured technical elements from natural language input; (ii) uses those elements to drive a generative AI model to produce search-oriented prompt sentences; (iii) orchestrates multi-source IP and legal data retrieval; (iv) computes similarity measures between user technology and right information; and (v) uses a further generative AI model run to transform these machine-level metrics into a structured, numerical risk index and explanatory text. Without such integration, the system tends to exhibit duplicated queries, redundant accesses to external information sources, and fragmented intermediate data structures, degrading performance and scalability on a computing infrastructure.

Moreover, routing of IP risk evaluation results to appropriate internal units, such as different business domains or processing systems, is often performed manually or via static rules that are decoupled from the actual computed risk and legal context. In these architectures, the processor cannot systematically classify right information and related legal information in conjunction with generated evaluation information and risk evaluation results. Consequently, the system is not able to automatically dispatch high-risk cases to specialized computational workflows or organizational units, which leads to delayed processing, increased error rates, and suboptimal utilization of computing resources and communication channels.

Therefore, there is a need for a computer-implemented system in which a processor cooperates with a generative AI model via carefully constructed prompt sentences to: (i) perform structured language analysis of user input; (ii) build and update an integrated IP and legal information group; (iii) compute similarity and risk metrics in a machine-optimizable format; (iv) generate numerical risk indices and explanatory text as a machine-usable output; (v) adapt processing and presentation based on user emotional state; and (vi) automatically classify and route results to appropriate computational or organizational targets. By implementing these operations in a coordinated, processor-executable flow, the computer itself can be improved in terms of relevance of retrieved data, efficiency of external resource usage, adaptability of internal algorithms, and automation of downstream processing.

The specific processing by the specific processing unit 290 of the data processing device 12 in Application Example 2 is realized by the following means.

The present invention provides a server comprising a processor configured to receive input information including technical information from a user, perform language analysis on the input information to extract technical elements and related terms, generate a prompt sentence for a generative artificial intelligence model based on the technical elements and the related terms, input the prompt sentence into the generative artificial intelligence model to obtain an analysis result including a summary of the technical information, search terms, and classification information, acquire intellectual property information and legal information from at least one external information source based on the analysis result, integrate the intellectual property information and the legal information to construct a group of intellectual property information, search, from the group of intellectual property information, right information similar to the technical information, calculate a similarity between the technical information and the right information and generate evaluation information for evaluating an intellectual property infringement risk based on the similarity and case information related to the legal information, generate a further prompt sentence for the generative artificial intelligence model based on the evaluation information and the right information, input the further prompt sentence into the generative artificial intelligence model to generate a risk evaluation result including a numerical index and an explanatory text regarding the intellectual property infringement risk, provide the risk evaluation result as output data to a user terminal, analyze an emotional state of the user based on the input information or behavior information of the user, adjust an evaluation criterion of the intellectual property infringement risk and a presentation style of the explanatory text in the risk evaluation result in accordance with the emotional state, and classify the right information and the related legal information into a plurality of business domains or processing functions based on the evaluation information and the risk evaluation result and assign and notify the risk evaluation result to a predetermined organizational unit or processing system in accordance with a classification result. This enables the computer system to automatically transform unstructured user descriptions into structured technical and legal representations, to drive external data retrieval and similarity computation in a resource-efficient and relevance-aware manner, to generate machine-usable numerical risk indices and explanatory narratives via coordinated interaction with a generative AI model, to dynamically adapt internal processing and output presentation based on user emotional state, and to route high-priority risk information to appropriate computational and organizational targets, thereby improving the overall functioning, scalability, and responsiveness of the underlying computing infrastructure.

The term “input information” refers to information supplied by a user to the system, including at least a natural-language description of a technology, service, or feature, and optionally including metadata such as project type, use case, time information, or other contextual data.

The term “technical information” refers to information describing functional, structural, or operational aspects of a technology, service, or feature, such as processing steps, data flows, system components, interfaces, or usage scenarios.

The term “user” refers to any person or organization that operates a terminal or client device and provides input information to the system in order to obtain an intellectual property risk evaluation or related analysis.

The term “language analysis” refers to computational processing of natural-language text performed by the processor, including at least one of tokenization, normalization, part-of-speech tagging, syntactic parsing, entity extraction, keyword extraction, or semantic classification.

The term “technical elements” refers to technical features identified from the technical information by the language analysis, including functional components, processing operations, data types, data flows, control logic, or system configurations.

The term “related terms” refers to terms that are semantically or contextually associated with the technical elements, including synonyms, domain-specific terminology, classification codes, or other expressions useful for searching or categorizing information.

The term “prompt sentence” refers to a machine-readable instruction string or text sequence generated by the processor and provided as input to a generative AI model in order to request a specific analysis, transformation, or generation of information.

The term “generative artificial intelligence model” refers to a computational model that, based on input data including at least one prompt sentence, is configured to generate new information such as summaries, classifications, search terms, explanations, or other natural-language or structured outputs.

The term “analysis result” refers to data output from the generative artificial intelligence model in response to a prompt sentence, the data including at least one of a summary of the technical information, search terms, classification information, feature lists, or other structured or unstructured analytical content.

The term “summary of the technical information” refers to a condensed representation of the technical information generated by the system, including the essential functional and structural aspects of the technology expressed with reduced length compared to the original input.

The term “search terms” refers to words, phrases, or codes generated by the system for use in searching information sources, including at least keywords and domain-specific identifiers suitable for retrieving relevant intellectual property or legal documents.

The term “classification information” refers to information representing categories or classes assigned to the technical information, such as technology domains, subject-matter categories, or standardized classification codes suitable for intellectual property searches.

The term “external information source” refers to any information system or repository that is external to the server and accessible via a communication network, including at least one of an intellectual property database, a legal database, or a regulatory information service.

The term “intellectual property information” refers to information related to intellectual property rights, including at least one of patent documents, patent applications, design registrations, trademarks, copyright records, or associated bibliographic data and descriptions.

The term “legal information” refers to information related to legal norms and decisions, including at least one of statutes, regulations, rules, guidelines, legal opinions, or case law data.

The term “group of intellectual property information” refers to a data structure maintained by the system that integrates and organizes intellectual property information and legal information obtained from one or more external information sources into a unified collection.

The term “right information” refers to information about specific intellectual property rights included in the group of intellectual property information, including identifiers, claims, scopes, ownership data, and other characteristics of the rights.

The term “similar right information” refers to right information that exhibits a similarity above a predetermined threshold with respect to the technical information, the similarity being determined using at least one similarity measure computed by the system.

The term “similarity” refers to a quantitative indication of likeness between the technical information and the right information, computed by the processor using at least one metric such as vector similarity, keyword overlap, or semantic-distance evaluation.

The term “evaluation information” refers to data structures generated by the processor that aggregate similarity values, case information, and other analytical parameters, and that are usable to evaluate an intellectual property infringement risk.

The term “intellectual property infringement risk” refers to a likelihood or degree to which the technical information, if implemented or used, may fall within the scope of one or more existing intellectual property rights.

The term “case information” refers to data related to legal disputes or judicial decisions, including at least case identifiers, parties, issues, holdings, and reasoning, and being associated with the legal information in the group of intellectual property information.

The term “risk evaluation result” refers to an output of the system including at least a numerical representation of the intellectual property infringement risk and an explanatory text describing the basis and context of the risk.

The term “numerical index” refers to a numeric value or score included in the risk evaluation result that quantitatively expresses the evaluated intellectual property infringement risk according to a predetermined scale.

The term “explanatory text” refers to natural-language content included in the risk evaluation result that explains or justifies the numerical index, including references to technical elements, right information, and case information.

The term “output data” refers to data provided by the processor to a user terminal for presentation, the data including at least the risk evaluation result and optionally additional structured or unstructured elements.

The term “user terminal” refers to any computing device operated by the user that is configured to communicate with the server, including at least one of a workstation, a portable terminal, a smartphone, a tablet device, or a head-mounted display.

The term “notification information” refers to output data configured to inform the user about the presence or status of a risk evaluation result, including but not limited to alerts, push notifications, or summary messages.

The term “report information” refers to output data in a form suitable for human review or recordkeeping, including structured or formatted documents containing the risk evaluation result and related analytical details.

The term “emotional state” refers to an affective condition of the user inferred from user-provided text, audio, behavior logs, or other signals, the condition including at least one of anxiety, fear, confidence, joy, or neutrality.

The term “behavior information” refers to data indicative of user actions in interacting with the system, including at least input frequency, navigation patterns, response selections, and timing information.

The term “evaluation criterion” refers to a parameter or rule set used by the processor to interpret similarity values, case information, or other analytical data in order to determine the intellectual property infringement risk.

The term “presentation style” refers to formatting and expression characteristics of the explanatory text, including tone, level of detail, structure, emphasis, and graphical or textual layout used in presenting the risk evaluation result.

The term “business domain” refers to a functional area of activity within an organization that is associated with a particular class of technologies, products, or services, such as legal affairs, research and development, or product planning.

The term “processing function” refers to a type of computational or workflow processing performed within the system or an associated system, including at least document review, escalation handling, or compliance checking.

The term “organizational unit” refers to an administrative subdivision of an organization, such as a department, team, or role group, that is configured to receive and act on risk evaluation results.

The term “processing system” refers to a computational subsystem or external processing environment that is capable of receiving risk evaluation results and performing further automated or semi-automated processing based on those results.

In one embodiment, a server cooperates with a terminal operated by a user to perform intellectual property risk evaluation using a generative AI model driven by structured prompt sentences. The server includes at least one processor, a memory, a non-volatile storage device, and a network interface. The terminal includes at least one processor, a display, an input interface, and a communication interface. The server and the terminal communicate via a data network using a standard transport protocol.

The server executes an application program implemented on an application platform, for example on a general-purpose operating system. The server program is composed of multiple software modules, including at least: an input reception module, a natural language processing module, a feature extraction module, a prompt generation module, a generative AI interaction module, an external data source access module, a similarity computation module, an evaluation information generation module, an emotion analysis module, a routing and classification module, and an output formatting module. The server stores configuration data, intermediate feature vectors, similarity matrices, risk scores, and session metadata in a database management system such as a relational database or a key-value store. The server optionally indexes textual content using a search engine.

The terminal executes client software such as a web browser, a mobile application, or a dedicated thin client. The terminal program includes a user interface module, a communication module, and optionally an on-device emotion estimation module. The terminal displays input forms for technical descriptions and follow-up questions, and displays risk evaluation results, lists of related rights, and explanatory text received from the server.

The server uses a natural language processing module that may be implemented using a library such as a syntactic and semantic analysis toolkit. The natural language processing module tokenizes user input text, performs lemmatization, and applies part-of-speech tagging. The natural language processing module constructs a dependency parse tree and identifies noun phrases and verb phrases that are likely to correspond to technical components and operations. The server reduces this analysis to structured feature sets representing technical elements (for example, “real-time location tracking,” “nearest recommendation calculation,” “client-server communication”) and related terms (for example, synonyms and domain labels).

The server stores the extracted technical elements and related terms in a structured data object, such as a record containing lists of tokens, an embedding vector, and classification tags. The server may generate embedding vectors using a transformer-based encoder network. In one embodiment, the encoder is a multi-layer neural network with self-attention layers and feedforward layers. The server applies the encoder to token sequences representing the user description and obtains a dense vector of fixed dimension as a representation of the entire description. The server stores this vector in a feature table to reuse it during similarity computation.

The server uses a generative AI interaction module to communicate with a generative AI model. The generative AI model may be an autoregressive transformer model trained on a large corpus of technical and legal texts. The model includes multiple self-attention layers, feedforward layers, and a token embedding layer. The server does not treat the model as a black box but instead uses it according to specified prompts and constraints. The server defines prompt sentences to control the behavior of the generative AI model and to obtain reproducible, structured outputs.

The server generates a first category of prompt sentences to normalize and enrich technical descriptions. For example, the server may generate a prompt sentence:

“You are an IP search assistant. Summarize the following new technical feature in one paragraph, list its core technical components as bullet points, and propose 10 search keywords and at least one classification code for patent searches.”

The server concatenates this prompt sentence with the user's raw description and sends the combined text to the generative AI model. The model outputs a structured natural-language response that the server post-processes. The server uses rule-based parsing and pattern matching to extract lists of technical components, search keywords, and classification codes from the generated text. The server then stores these extracted elements into structured fields in the database.

The server uses these structured fields to generate parameterized queries for external information sources. The external information source access module communicates with one or more intellectual property databases and legal databases via application programming interfaces. The server formats query strings using the search keywords and classification codes and includes filters such as date ranges and jurisdictions. The server then submits these requests using an HTTP client library and receives result sets encoded in structured data formats such as JSON or XML.

The server transforms each received result into an internal data structure representing intellectual property information. Each record may include a right identifier, title, abstract, claim text, applicant or owner, publication date, and classification codes. The server performs normalization on character encodings and field names, and stores the records in relational tables. For efficient search and retrieval, the server may also create inverted indexes on text fields using a search engine. The server can thus reuse indexed data to accelerate later searches and similarity computations, which improves performance compared to naïve ve repeated keyword queries.

The server employs a similarity computation module to evaluate how closely the user's technical information matches a given right. The similarity computation module uses the feature vector of the user description and the feature vectors of candidate rights, which are computed using the same encoder architecture. The server computes similarity values using a cosine similarity computation implemented in numerical linear algebra libraries. For each candidate right, the server calculates a similarity score and then retains rights whose scores exceed a configurable threshold. The server can also compute auxiliary measures such as keyword overlap counts or Jaccard coefficients for term sets and integrate them into a composite similarity metric.

The server generates evaluation information by combining similarity scores, related legal case information, and classification data. The server may represent evaluation information as a tuple including an aggregated similarity score, a list of matched claims, a list of relevant legal citations, and a set of feature flags indicating types of overlap (for example, “method overlap,” “system architecture overlap,” “data structure overlap”). The server stores this evaluation information in a dedicated table with references to both the user session and the rights.

The server uses a second category of prompt sentences to obtain risk evaluation results. For example, the server may generate a prompt sentence:

“You are an IP risk analyst. Read the following description of a new technology and the list of similar rights with their similarity scores and short summaries. Evaluate the likelihood that the new technology infringes these rights on a scale from 0 to 100, explain the main reasons, and recommend concrete mitigation steps.”

The server appends to this prompt sentence a normalized summary of the user technology, a formatted list of similar rights including their similarity scores, and short summaries of related legal cases. The generative AI model processes this combined input and outputs an assessment that includes a numerical risk level and explanatory text. The server parses the output to extract the numerical index, to segment explanation sections, and to map each comment to specific rights.

In order to avoid relying on purely abstract model behavior, the server defines explicit evaluation criteria. The server interprets similarity scores, number of overlapping claims, and presence of adverse legal decisions according to decision rules such as thresholding and weighting. For example, the server may use a rule that if the top similarity score exceeds a predefined value and there exists at least one legal case confirming enforcement of a similar claim, the base risk index cannot be below a specified minimum. The server may then use the generative AI output as a refinement layer to adjust the risk index within a narrow range and to generate a human-readable explanation.

The server executes an emotion analysis module to estimate the user's emotional state. The server may send user-provided text (such as a comment “I am very worried about infringement”) to an emotion recognition service or employ a local classification model. The model may be a neural network classifier trained on labeled text data to output probability distributions over emotional categories. The classifier may use a transformer encoder followed by a classification head with a softmax output layer. During training, the model may minimize a cross-entropy loss using gradient descent. The server stores the resulting emotional categories and confidence levels and uses them to adjust subsequent processing.

The server modifies evaluation criteria and presentation style according to the estimated emotional state. For example, when the emotion analysis module reports that the user is anxious, the server increases the weight assigned to similarity score and adverse case law in the decision rules. The server also constructs a third category of prompt sentences instructing the generative AI model to adopt a specific tone and structure. An example of such a prompt sentence is:

“Rewrite the following risk assessment in a calm, detailed, and reassuring tone suitable for a user who feels anxious. Clearly separate sections titled ‘Main Risks’, ‘Why This Matters’, and ‘Suggested Next Steps’.”

By controlling both numerical thresholds and generative formatting in a coordinated fashion, the server improves the consistency and clarity of outputs. This architecture yields a technical effect beyond simple automation, because the system adapts computational paths and model usage based on user emotion in a way that reduces unnecessary external queries and focuses computational resources on high-risk scenarios.

The server also executes a routing and classification module to determine appropriate destinations for risk evaluation results. The routing and classification module associates business domains or processing functions with certain rights and technologies. The server may represent each business domain by a vector in the same embedding space as technical descriptors. The server computes a similarity between the user's technology vector and each domain vector and assigns the session to the domains with highest similarity. The server further considers the risk evaluation result and assigns high-risk cases to specialized processing systems such as internal legal review workflows, while low-risk cases may be archived with minimal routing.

The server then generates notification messages or reports for each selected organizational unit or processing system. The server constructs these messages using templates and may again use a prompt sentence to transform technical content into a concise summary for experts. For example, the server may use:

“Create a concise technical and legal summary of the following risk report for internal counsel, focusing on the most critical overlapping features and pending deadlines.”

By automatically classifying and routing results, the server reduces response time and supports system-level load balancing. This routing is not merely a business rule; it is driven by computed similarity and risk metrics, and thus reflects internal system state and algorithmic decisions.

The terminal receives risk evaluation results and related notifications from the server. The terminal decodes structured data and renders it using a graphical user interface. The terminal can display an overall risk level (for example, via a gauge or colored indicator), lists of similar rights with their risk contributions, and the explanatory text produced by the generative AI model. The terminal may allow the user to filter or expand details, but the core layout is determined by the server according to the classification and emotional context.

The server thereby improves technical performance in several ways. First, by generating and using structured prompt sentences derived from language analysis and feature extraction, the server reduces the number of irrelevant documents fetched from external databases. This reduces communication load and improves latency. Second, by using an embedding-based similarity computation with pre-computed vectors, the server enables efficient matrix operations that scale better with the number of documents than naïve ve text comparison. Third, by storing and reusing evaluation information and intermediate vectors, the server avoids recomputing features for repeated or related queries, which improves computational efficiency. Fourth, by adjusting evaluation criteria and generative formatting based on emotional state, the server reduces the number of user-initiated retries and follow-up questions, thereby reducing total system load.

The generative AI model itself may be implemented as a multi-layer transformer neural network with a specified number of attention heads and hidden units. The model is trained using a large set of paired prompt and response examples, including technical descriptions, patent texts, and legal explanations. During training, the model parameters are updated using a gradient-based optimizer and a loss function such as cross-entropy over token predictions. The server may fine-tune the model on a domain-specific corpus so that the model learns to produce outputs that conform to the required structure, such as bullet lists, risk scores embedded in text, or explicit section headings. The server benefits from this training because the model outputs can be parsed using deterministic rules, enabling conversion from natural language to structured representation without heavy human supervision.

In one alternative embodiment, the server deploys multiple generative AI models with different architectures or training data. The server may use a smaller, faster model for initial summarization and keyword extraction, and a larger, more accurate model for final risk explanation. The server selects which model to call based on complexity of the input and current system load. This dynamic model selection and staged prompting provide additional technical advantages by reducing processing time for simple cases while preserving high accuracy for complex cases.

In another embodiment, the server integrates a rule-based engine with the generative AI module. The rule-based engine enforces non-conventional rules derived from domain knowledge. For example, the engine may require that a risk index cannot exceed a particular threshold if no overlapping independent claim is found, regardless of generative AI output. The server uses the engine to validate or correct generative AI outputs, thus reducing errors due to model hallucinations and improving overall reliability.

In yet another embodiment, the server collects interaction logs and uses them to refine both similarity thresholds and routing policies. For example, the server observes which rights and risk scores historically triggered manual legal interventions and adjusts thresholds so that the system more closely aligns with expert decisions. The server may train a supervised learning module on historical pairs of evaluation information and expert labels to predict whether a case should be escalated. The server then integrates this module's output into the routing and classification decision logic.

The system is therefore not limited to simple automation of human review; instead, the server implements a multi-stage, feature-driven, and model-guided pipeline that changes how data is represented, routed, and processed within computing hardware. The server converts unstructured text into machine-interpretable feature vectors, uses these vectors to orchestrate network requests and database operations, and coordinates multiple algorithmic components, including generative AI models and deterministic rule engines. These technical operations improve speed, scalability, and accuracy of risk evaluation on a computing infrastructure in a way that is not achievable using traditional manual search and interpretation.

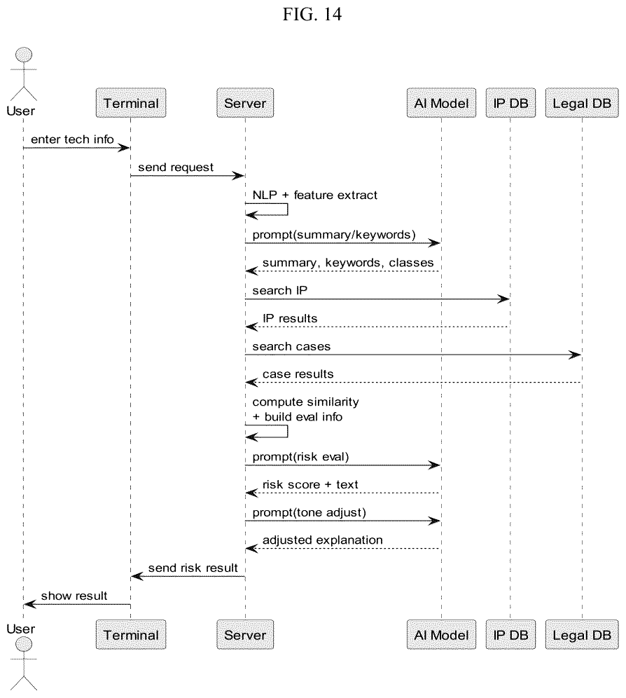

The following describes the processing flow using FIG. 14.

### Step 1:

User operates the terminal to input technical information and optional comments.
User enters a natural-language description of a technology, service, or feature into an input field on the terminal, and may additionally type comments expressing concerns (for example, about infringement) or expectations.
Input: free-form text describing the technology and optional comment text.
Output: structured request data on the terminal (for example, fields for description, project type, and comment).
Terminal converts the user's input into a structured format (for example, an internal object with fields such as ‘technical_description’ and ‘user_comment’) without yet altering the content, and prepares it for transmission.

### Step 2:

Terminal transmits the structured request data to the server.
Terminal opens a network connection to the server using a secure protocol and sends the structured request data as a payload in a request message.
Input: structured request data containing the user's technical description and comment.
Output: network message delivered to the server.
Terminal serializes the data (for example, into a text-based representation), sets appropriate headers, and hands the serialized data to the communication stack for transport to the server.

### Step 3:

Server receives and logs the user request.
Server accepts the incoming network message, parses it to reconstruct the structured request object, and stores a copy in a persistent request log for traceability.
Input: serialized request message from the terminal.
Output: parsed request object and a corresponding log record in storage.
Server validates the request format, assigns a session identifier, and writes a row into a log table including timestamp, user identifier, and raw request content.

### Step 4:

Server performs language analysis on the technical description.
Server applies a natural-language processing pipeline to the ‘technical_description’ field to identify technical elements and related terms.
Input: user's technical description text.
Output: a set of extracted technical elements, related terms, and a normalized text representation.
Server tokenizes the text, performs part-of-speech tagging and lemmatization, identifies noun phrases and verb phrases, and then groups them into candidate technical features (for example, “real-time location tracking”) and associated terms (for example, “nearest store recommendation”). Server constructs a normalized version of the description by resolving basic synonyms and removing non-technical filler text.

### Step 5:

Server computes a feature representation of the technical description.
Server converts the normalized description into a numerical feature vector and metadata for later similarity computation.
Input: normalized technical description from Step 4.
Output: feature vector and metadata object.
Server applies a pre-trained text encoder (for example, a transformer-based encoder) to the tokenized description and obtains a dense vector of fixed dimension. Server stores this vector along with token lists, part-of-speech tags, and extracted entities in a feature table keyed by the session identifier.

### Step 6:

Server generates a first prompt sentence for enriching and structuring the technical description.
Server uses extracted technical elements and related terms to compose a prompt sentence that instructs a generative AI model to summarize and structure the description.
Input: technical elements, related terms, and normalized text from Steps 4 and 5.
Output: a first prompt sentence string and a combined input text for the generative AI model.
Server constructs a prompt such as:
“You are an IP search assistant. Summarize the following new technical feature in one paragraph, list its core technical components as bullet points, and propose 10 search keywords and at least one classification code for patent searches. Description: [normalized description].”
Server concatenates the instruction with the normalized description to form the model input.

### Step 7:

Server interacts with the generative AI model to obtain an analysis result.
Server sends the combined prompt and description to the generative AI model and receives a structured natural-language response.
Input: first prompt sentence and normalized description.
Output: generated text containing a summary, a list of technical components, search keywords, and classification codes.
Server transmits the text input to the model's API, waits for the model to generate tokens, and then collects the output into a single text string. Server checks the string for structural markers such as bullet points, numbered lists, and headings that indicate different sections.

### Step 8:

Server parses the generated analysis result into structured fields.
Server applies rule-based pattern matching and simple parsing to separate the summary, component list, keyword list, and classification codes.
Input: generated analysis text from Step 7.
Output: a structured analysis object containing summary, technical components, search terms, and classification information.
Server scans the text for section labels or delimiters (for example, “Summary:”, “Core components:”, “Keywords:”) and extracts the content into list structures. Server stores these lists and codes in database fields associated with the session.

### Step 9:

Server performs emotion analysis on the user's comment or behavior.
Server analyzes the user's comment text, and optionally historical behavior data, to estimate the user's emotional state.
Input: user comment text and, optionally, session behavior logs.
Output: an emotional state classification and confidence values.
Server passes the comment text to an emotion classifier model that outputs probabilities for categories such as anxiety, confidence, or neutrality. Server stores the dominant category and scores, and sets a mode flag (for example, strict evaluation mode when anxiety is high) that will influence later decision thresholds and formatting.

### Step 10:

Server generates search queries for external intellectual property and legal data sources.
Server uses the search terms and classification information to build query strings suited to external databases.
Input: search term list and classification codes from Step 8.
Output: one or more structured query objects targeted at external IP and legal APIs.
Server groups terms into logical expressions (for example, AND/OR combinations), attaches filters such as date ranges and jurisdictions, and formats the query according to each external system's specification. Server creates a list of query objects, each including endpoint information and query parameters.

### Step 11:

Server retrieves intellectual property information and legal information from external sources.
Server sends the query objects to external IP and legal databases and collects the responses.
Input: query objects from Step 10.
Output: raw response data sets containing right records and legal materials.
Server issues network requests to each external endpoint, receives response payloads (for example, JSON arrays of documents), and performs basic validation such as schema checking. Server then passes the raw responses to a data transformation layer.

### Step 12:

Server normalizes and stores external data into an internal group of intellectual property information.
Server transforms the raw responses into a uniform internal schema and stores them in internal database tables.
Input: raw IP and legal data from Step 11.
Output: internal records representing intellectual property information and legal information, organized into a unified group.
Server maps external field names to internal fields (for example, mapping external “patentNumber” to internal “right_id”), converts date formats, and normalizes text encodings.
Server inserts or updates rows in tables for rights, legal cases, and statutes, and links them via foreign keys to build a coherent group of intellectual property information for the session.

### Step 13:

Server computes similarity between the user's technical information and the retrieved rights.
Server compares the feature vector of the user's description with feature vectors of retrieved rights to calculate similarity scores.
Input: user description feature vector from Step 5 and right feature vectors derived from the stored rights.
Output: similarity scores associated with each right and a filtered list of similar rights.
Server encodes the text of each right (for example, rights' abstracts or claims) with the same encoder used for the user description, obtains vectors, and then computes cosine similarity between the user vector and each right vector. Server filters out rights below a preset similarity threshold and produces a list of similar rights sorted by similarity.

### Step 14:

Server aggregates related legal case information for similar rights.
Server identifies legal cases linked to the similar rights and extracts key information for evaluation.
Input: list of similar rights from Step 13 and internal links between rights and legal cases.
Output: a collection of case summaries and references associated with the similar rights.
Server queries the legal case table using right identifiers as keys, retrieves case metadata and reasoning summaries, and compiles them into a structure that associates each similar right with its relevant case set.

### Step 15:

Server generates evaluation information based on similarity and legal context.
Server combines similarity scores and case information to produce evaluation information for risk assessment.
Input: similarity scores from Step 13 and case information from Step 14.
Output: evaluation information objects containing composite metrics and flags.
Server computes composite scores by weighting similarity, presence of adverse decisions, and number of overlapping features. Server sets feature flags indicating respect to which components the overlap appears, and stores the resulting evaluation information in a dedicated table for the session.

### Step 16:

Server creates a second prompt sentence for risk evaluation using a generative AI model.
Server constructs a prompt sentence that instructs the generative AI model to produce a risk index and explanation based on evaluation information and similar rights.
Input: evaluation information objects, list of similar rights, and user's normalized technical description.
Output: a second prompt sentence and combined input content for the generative AI model.
Server generates a text such as:
“You are an IP risk analyst. Read the following description of a new technology and the list of similar rights with their similarity scores and case summaries. Evaluate the likelihood that the new technology infringes these rights on a scale from 0 to 100, explain the main reasons, and recommend concrete mitigation steps.”
Server appends structured lists of similar rights and summarized case information to this prompt sentence.

### Step 17:

Server obtains a risk evaluation result from the generative AI model.
Server calls the generative AI model with the second prompt and combined content to generate a risk evaluation result.
Input: second prompt sentence and appended technical and legal content.
Output: generated text containing a suggested numerical risk score and detailed explanation.
Server sends the text input to the model, receives token outputs, and concatenates them into a coherent evaluation document. Server then scans the document for explicit or implicit risk scores and explanatory segments.

### Step 18:

Server parses and normalizes the risk evaluation result.
Server extracts a numerical index and explanatory text from the generated evaluation document.
Input: generated risk evaluation text from Step 17.
Output: a normalized risk index value and segmented explanatory text sections.
Server uses pattern recognition rules (for example, searching for phrases like “risk score:”) and number parsing to obtain a numeric value. Server segments the text into sections such as “Main risks,” “Reasons,” and “Recommended actions,” either by explicit headings or by heuristic rules, and stores these segments in separate fields.

### Step 19:

Server adjusts evaluation criteria and presentation based on the user's emotional state.
Server modifies the risk index and chooses an appropriate explanation style according to the emotional state determined earlier.
Input: normalized risk index and explanatory sections from Step 18, and emotional state data from Step 9.
Output: adjusted risk index and formatted content parameters.
Server applies decision rules that may increase or leave unchanged the risk index when the user is anxious, and selects formatting parameters such as level of detail and tone. Server does not change underlying facts but controls rounding and emphasis based on the emotional mode.

### Step 20:

Server generates a third prompt sentence for tone-adjusted explanation, if needed.
Server composes a prompt sentence instructing the generative AI model to rewrite the explanatory text according to the selected tone and structure.
Input: explanatory text sections and tone parameters from Step 19.
Output: a third prompt sentence and a combined rewrite request for the generative AI model.
Server builds text such as:
“Rewrite the following risk assessment in a calm, detailed, and reassuring tone suitable for a user who feels anxious. Clearly separate sections titled ‘Main Risks’, ‘Why This Matters’, and ‘Suggested Next Steps’.”
Server appends the original explanatory sections after this prompt sentence.

### Step 21:

Server obtains a tone-adjusted explanation from the generative AI model.
Server calls the generative AI model to rewrite the explanation according to the third prompt.
Input: third prompt sentence and original explanatory text.
Output: tone-adjusted explanatory text structured into labeled sections.
Server sends the rewrite request to the model, collects the returned text, and verifies that the required section titles are present. Server replaces the original explanation with the tone-adjusted version in the session record.

### Step 22:

Server composes final output data for the user terminal.
Server bundles the adjusted risk index, structured explanatory text, list of similar rights, and key case summaries into an output object.
Input: adjusted risk index, tone-adjusted explanatory text, similar rights list, and case summaries.
Output: a final response object ready to be sent to the terminal.
Server organizes data into logical groups for display (for example, general overview, detailed per-right analysis, legal background) and includes metadata such as timestamps and identifiers, then serializes the object for network transmission.

### Step 23:

Server sends the final response to the terminal.
Server transmits the final output object over the network back to the terminal associated with the session.
Input: final response object from Step 22.
Output: serialized response delivered to the terminal.
Server sets appropriate response headers, writes the serialized data to the network socket, and logs the response size and timing for monitoring.

### Step 24:

Terminal receives and parses the final response.
Terminal accepts the response from the server and reconstructs the structured response object.
Input: serialized final response from the server.
Output: in-memory data structures representing risk index, explanations, rights, and cases.
Terminal decodes and parses the serialized content, checks for integrity, and passes the parsed data to the user interface module.

### Step 25:

Terminal renders the risk evaluation result for the user.
Terminal displays the overall risk index, explanatory sections, and lists of similar rights and legal cases on the display.
Input: parsed response data from Step 24.
Output: rendered user interface on the terminal display.
Terminal draws graphical elements such as a risk gauge, tables listing similar rights with their contributions, and collapsible text sections for “Main Risks,” “Why This Matters,” and “Suggested Next Steps.” Terminal also enables interactive elements such as buttons for viewing detailed right information or downloading a report.

### Step 26:

User reviews the result and, if desired, submits follow-up questions.
User reads the displayed information and may decide to request additional guidance or design changes.
Input: rendered result on the terminal display.
Output: optional follow-up text input by the user.
User may type a follow-up such as “Describe concrete design-around strategies to avoid infringement of right X while preserving similar user experience,” which the terminal captures and prepares for a new request to the server.

### Step 27:

Server receives follow-up input and generates contextual prompt sentences for further analysis.
Server accepts the follow-up request, retrieves prior session data, and constructs a new prompt sentence that includes the follow-up question and relevant context.
Input: follow-up text from the user and previous session data (technical description, similar rights, evaluation information).
Output: contextual prompt sentence and combined content for another generative AI model call.
Server builds a prompt such as:
“Describe concrete design-around strategies to avoid infringement of the following right while preserving similar user experience, given the new technology description and overlapping features.”
Server appends the technical description and excerpts of the right to the prompt and sends it to the generative AI model for an additional response, which the server will later parse and return to the terminal in a similar manner as described in earlier steps.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

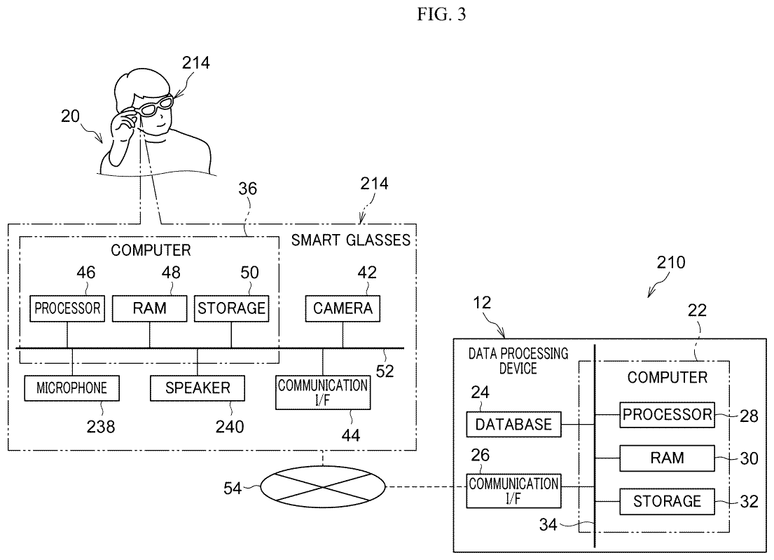

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

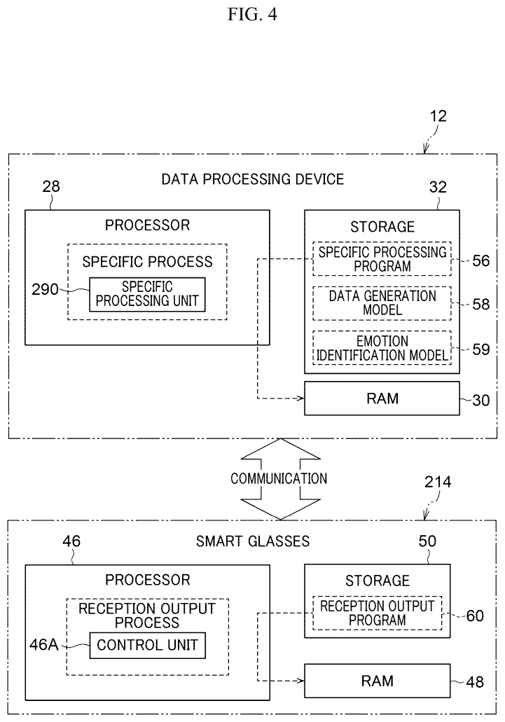

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

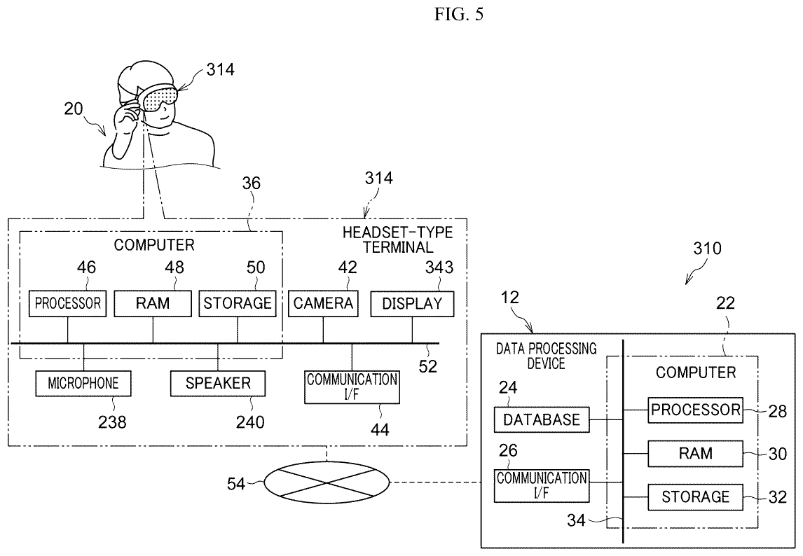

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

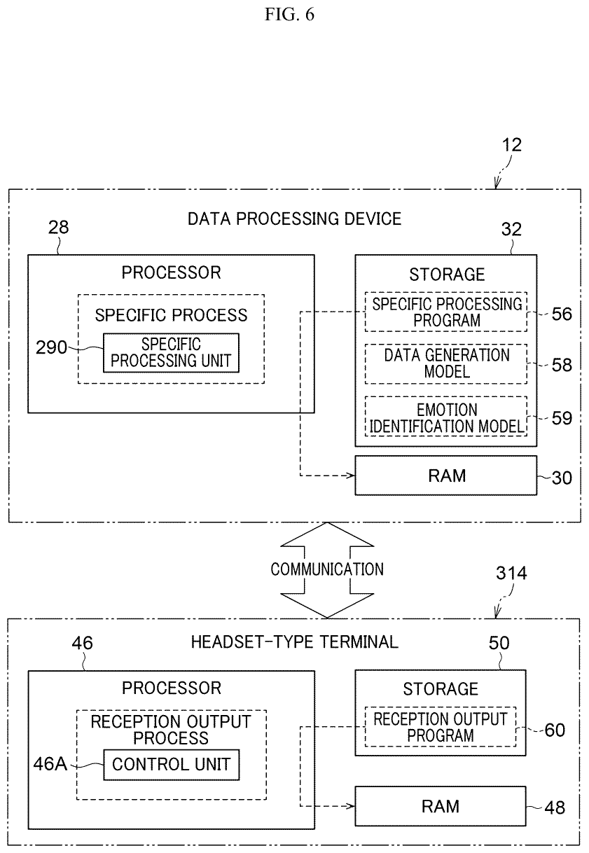

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve ve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

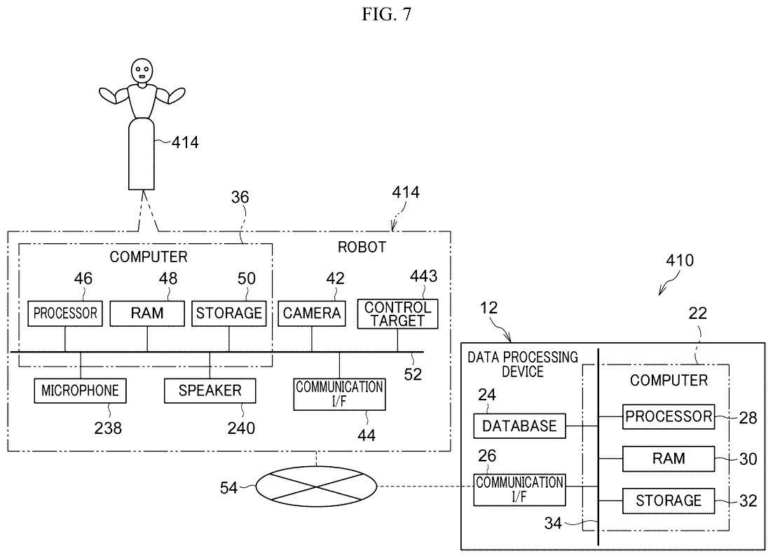

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

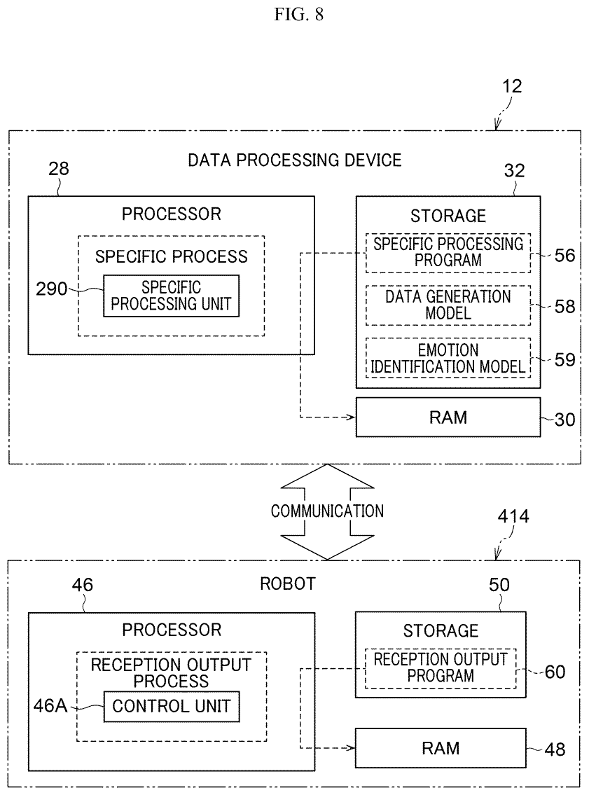

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve ve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

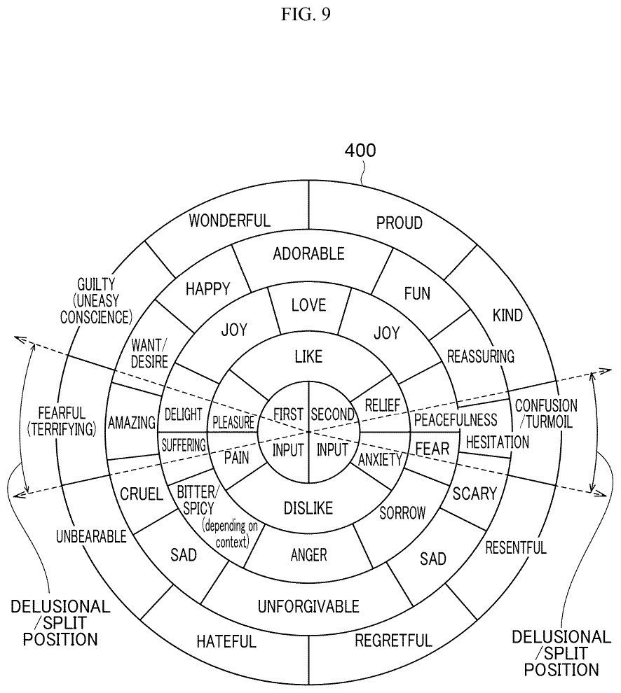

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

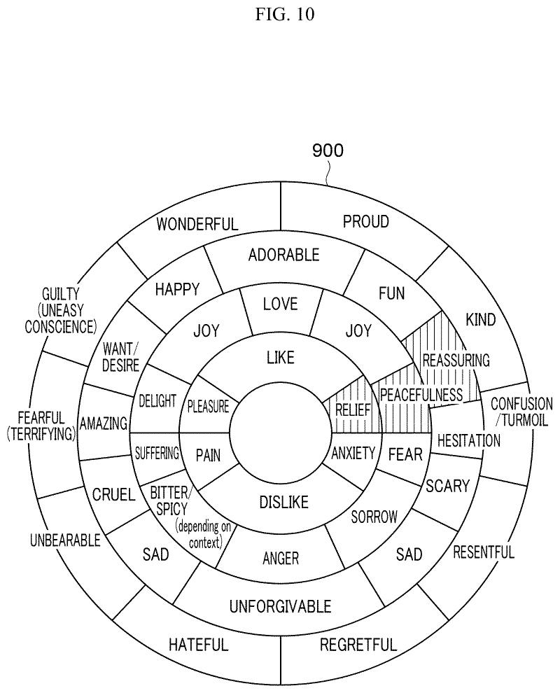

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, from an information processing terminal of a user, data indicating technical content relating to a business activity, acquire text data representing the technical content, and
perform normalization of terms, extraction of characteristic terms, and generation of a search query on the text data,
communicate with a plurality of intellectual property information storage apparatuses and legal information storage apparatuses on the basis of the text data and the search query,
acquire recorded data including right information from the intellectual property information storage apparatuses and recorded data including case information from the legal information storage apparatuses, and associate and store the acquired right information and case information,
generate a prompt sentence including the technical content, the right information, and the case information as an input text for a generative AI model, input the prompt sentence into the generative AI model, and acquire an analysis result concerning a correspondence relationship between the technical content and the right information and a possibility of infringement, and
generate evaluation result data including the right information and the case information related to the technical content on the basis of the analysis result, and transmit the evaluation result data to the information processing terminal to cause display control to be performed.

### (Supplementary 2)

The system according to supplementary 1,
wherein the processor is configured to
extract, from the analysis result, an evaluation index indicating a degree of infringement risk, and add risk classification information to the evaluation result data on the basis of the evaluation index and output the evaluation result data as structured data.

### (Supplementary 3)

The system according to supplementary 1,
wherein the processor is configured to
classify the right information and the case information related to the technical content on the basis of the analysis result, and generate notification information for distributing the evaluation result data to an internal responsible department or an external support entity in accordance with a classification result.

### Application Example 1

### (Supplementary 1)

A system comprising a processor,
wherein the processor is configured to
receive input information from a user terminal, the input information including technical elements related to a new function,
extract the technical elements included in the input information, add synonyms and related terms corresponding to the technical elements, and generate structured search information,
transmit a search request to a first information storage device storing patent information and to a second information storage device storing statute information or case law information,
based on the structured search information, and acquire the patent information from the first information storage device and, based on the acquired patent information, acquire the statute information or the case law information from the second information storage device,
summarize and integrate the input information, the patent information, and the statute information or the case law information to generate analysis target information, and generate a prompt sentence including the analysis target information and analysis content for evaluating intellectual property right infringement risk based on the analysis target information,
input the prompt sentence to a generative AI model and acquire output information from the generative AI model, the output information including an evaluation result of the intellectual property right infringement risk with respect to the analysis target information,
analyze the output information, map the evaluation result of the intellectual property right infringement risk to a quantitative or qualitative evaluation index, and generate evaluation result information associated with the related patent information and the statute information or the case law information, and
transmit the evaluation result information to the user terminal as display information.

### (Supplementary 2)

The system according to supplementary 1,
wherein the processor is configured to
generate, based on the evaluation result of the intellectual property right infringement risk included in the output information, design change candidate information including modification proposals or design-around proposals for components of the new function, and provide the design change candidate information to the user terminal together with the evaluation result information.

### (Supplementary 3)

The system according to supplementary 1,
wherein the processor is configured to
generate classification information corresponding to a predetermined organizational category or business process category based on the technical elements included in the input information and the evaluation result of the intellectual property right infringement risk, sort the evaluation result information to a responsible division or role according to the classification information to determine notification destination information, and transmit the evaluation result information to the responsible division or role based on the notification destination information.

### Example 2

### (Supplementary 1)

A system comprising a processor,
wherein the processor is configured to
receive, from a terminal, target technology information and search condition information, and set, based on the target technology information, intellectual property information and regulation information stored in a plurality of information storage devices as search targets; and
acquire document information from the intellectual property information set as the search targets, perform preprocessing on the document information by using natural language processing techniques and similarity calculation techniques based on a degree of relevance between the document information and the target technology information, convert the document information into a format inputtable to a generative information processing model, and generate a prompt sentence including the target technology information and claim information having a high degree of relevance; and
input the prompt sentence to the generative information processing model, obtain, from the generative information processing model, analysis result information regarding a correspondence between the target technology information and the claim information and an intellectual property infringement risk, analyze the analysis result information as structured information, and calculate an infringement risk evaluation value for the target technology information by converting similarity information and risk level information included in the structured information into numerical information and aggregating the numerical information; and
generate an evaluation result document based on the infringement risk evaluation value and the structured information, and transmit the evaluation result document to the terminal.

### (Supplementary 2)

The system according to supplementary 1,
wherein the processor is configured to
perform an embedding process that converts the document information and the target technology information into numerical vector information, calculate similarity between the numerical vector information, extract a candidate set of the claim information based on the similarity, and selectively include the claim information contained in the candidate set in the prompt sentence so as to control input information to the generative information processing model.

### (Supplementary 3)

The system according to supplementary 1,
wherein the processor is configured to
rank a plurality of pieces of the intellectual property information in the evaluation result document based on the infringement risk evaluation value, add explanation information including, for each piece of the intellectual property information, corresponding claim information, overlapping technical element information, and reason explanation information, format the evaluation result document into a report document format, and generate a file as the evaluation result document in the report document format.

### Application Example 2

### (Supplementary 1)

A system comprising a processor,
wherein the processor is configured to
receive input information including technical information from a user and perform language analysis on the input information to extract technical elements and related terms,
generate a prompt sentence for a generative artificial intelligence model based on the technical elements and the related terms, input the prompt sentence into the generative artificial intelligence model, and obtain an analysis result including a summary of the technical information, search terms, and classification information,
acquire intellectual property information and legal information from an external information source based on the analysis result, integrate the intellectual property information and the legal information to construct a group of intellectual property information, and search, from the group of intellectual property information, right information similar to the technical information,
calculate a similarity between the technical information and the right information and generate evaluation information for evaluating an intellectual property infringement risk based on the similarity and case information related to the legal information,
generate a prompt sentence for the generative artificial intelligence model based on the evaluation information and the right information, input the prompt sentence into the generative artificial intelligence model, and generate a risk evaluation result including a numerical index and an explanatory text regarding the intellectual property infringement risk, and
provide the risk evaluation result as output data to a user terminal and present the output data as notification information or report information.

### (Supplementary 2)

The system according to supplementary 1,
wherein the processor is configured to
analyze an emotional state of the user based on the input information or behavior information of the user and adjust an evaluation criterion of the intellectual property infringement risk and a presentation style of the explanatory text in the risk evaluation result in accordance with the emotional state.

### (Supplementary 3)

The system according to supplementary 1,
wherein the processor is configured to
classify the right information and the related legal information into a plurality of business domains or processing functions based on the evaluation information and the risk evaluation result, and assign and notify the risk evaluation result to a predetermined organizational unit or processing system in accordance with a classification result.

What is claimed is:

1. A system comprising:
circuitry configured to:
receive, via a communication interface coupled to a packet-switched network, from a terminal device, input data indicating technical content;
perform normalization of terms and extraction of characteristic terms from the input data to generate a search query;
transmit, via the communication interface, search requests to a plurality of information storage apparatuses based on the search query, and acquire recorded data from the plurality of information storage apparatuses;
generate a prompt sentence including the technical content and the recorded data for input to a generative neural network model;
input the prompt sentence to the generative neural network model to acquire analysis result data concerning a correspondence relationship between the technical content and the recorded data; and
transmit evaluation result data generated based on the analysis result data to the terminal device via the communication interface for presentation on the terminal device.

2. The system according to claim 1, wherein the circuitry is further configured to add synonyms and related terms corresponding to the characteristic terms extracted from the input data, and to generate structured search information based on the characteristic terms and the added synonyms and related terms.

3. The system according to claim 2, wherein the circuitry is configured to perform an embedding process that converts the recorded data and the input data into numerical vector information, calculate a similarity between the numerical vector information, and extract a candidate set of the recorded data based on the similarity.

4. The system according to claim 3, wherein the circuitry is configured to selectively include, in the prompt sentence, portions of the recorded data contained in the candidate set, thereby controlling an amount of input information provided to the generative neural network model.

5. The system according to claim 1, wherein the circuitry is further configured to analyze the analysis result data and extract an evaluation index indicating a degree of risk, and to add risk classification information to the evaluation result data based on the evaluation index.

6. The system according to claim 5, wherein the circuitry is configured to convert similarity information and risk level information included in the analysis result data into numerical information and aggregate the numerical information to calculate a risk evaluation value for the technical content.

7. The system according to claim 6, wherein the circuitry is configured to rank a plurality of items of the recorded data based on the risk evaluation value and to add, for each item, corresponding claim information, overlapping technical element information, and reason explanation information to the evaluation result data.

8. The system according to claim 7, wherein the circuitry is configured to format the evaluation result data into a report document comprising the ranked items with associated claim information and reason explanation information, and to transmit the report document to the terminal device.

9. The system according to claim 1, wherein the circuitry is further configured to analyze an emotional state of a user based on data acquired from the terminal device.

10. The system according to claim 9, wherein the circuitry is configured to adjust a risk evaluation included in the evaluation result data based on the emotional state, such that the evaluation result data is modified in accordance with a context of the user.

11. The system according to claim 10, wherein the circuitry is configured to incorporate the emotional state into the prompt sentence so that the generative neural network model generates the analysis result data in consideration of the emotional state of the user.

12. The system according to claim 1, wherein the circuitry is further configured to classify the recorded data and the analysis result data into categories corresponding to organizational departments or business process categories based on the analysis result data.

13. The system according to claim 12, wherein the circuitry is configured to generate notification information for distributing the evaluation result data to a responsible department or an external support entity in accordance with a classification result, and to transmit the notification information via the communication interface and the packet-switched network.

14. The system according to claim 13, wherein the circuitry is configured to generate, based on the analysis result data, design change candidate information comprising modification proposals for components of the technical content, and to provide the design change candidate information to the terminal device together with the evaluation result data.

15. The system according to claim 1, wherein the plurality of information storage apparatuses comprise a first information storage apparatus storing right information and a second information storage apparatus storing case information, and wherein the circuitry is configured to acquire the right information from the first information storage apparatus and, based on the acquired right information, acquire the case information from the second information storage apparatus.

16. The system according to claim 15, wherein the circuitry is configured to summarize and integrate the input data, the right information, and the case information to generate analysis target information, and to include the analysis target information in the prompt sentence together with analysis content for evaluating a risk with respect to the analysis target information.

17. The system according to claim 7, wherein the recorded data comprises patent information including patent claims, wherein the risk evaluation value indicates an intellectual property infringement risk, and wherein the evaluation result data comprises a patent infringement risk assessment report associating specific patent claims with overlapping technical elements of the technical content.

18. A system comprising:
circuitry configured to:
receive, via a communication interface coupled to a packet-switched network, from a terminal device, input data indicating technical content;
perform normalization of terms and extraction of characteristic terms from the input data, add synonyms and related terms, and generate structured search information;
transmit search requests to a first information storage apparatus and a second information storage apparatus via the packet-switched network based on the structured search information, and acquire right information from the first information storage apparatus and case information from the second information storage apparatus;
perform an embedding process to convert the input data and the acquired right information into numerical vector information, calculate a similarity, and extract a candidate set based on the similarity;
generate a prompt sentence including the technical content and the candidate set for input to a generative neural network model;
input the prompt sentence to the generative neural network model to acquire analysis result data;
convert similarity information and risk level information in the analysis result data into numerical information and calculate a risk evaluation value;
generate evaluation result data comprising the risk evaluation value, ranked items of the right information, and reason explanation information; and
transmit the evaluation result data to the terminal device via the communication interface.

19. The system according to claim 18, wherein the circuitry is further configured to classify the evaluation result data into categories corresponding to organizational departments based on the analysis result data, and to generate and transmit notification information for distributing the evaluation result data to a responsible department via the packet-switched network.

20. A method performed by circuitry, the method comprising:
receiving, via a communication interface coupled to a packet-switched network, from a terminal device, input data indicating technical content;
performing normalization of terms and extraction of characteristic terms from the input data to generate a search query;
transmitting, via the communication interface, search requests to a plurality of information storage apparatuses based on the search query, and acquiring recorded data from the plurality of information storage apparatuses;
generating a prompt sentence including the technical content and the recorded data for input to a generative neural network model;
inputting the prompt sentence to the generative neural network model to acquire analysis result data concerning a correspondence relationship between the technical content and the recorded data; and
transmitting evaluation result data generated based on the analysis result data to the terminal device via the communication interface for presentation on the terminal device.
